(19) United States
(12) Patent Application Publication
(10) Pub. No.: US 2025/0080176 A1
(43) Pub. Date: Mar. 6, 2025

(54) TYPE II PRECODER MATRIX INDICATOR (PMI) ENHANCEMENT FOR COHERENT JOINT TRANSMISSION (CJT)

(71) Applicant: Telefonaktiebolaget LM Ericsson (publ), Stockholm (SE)

(72) Inventors: Xinlin ZHANG, Västra Frölunda (SE); Daniele DAVOLI, Solna (SE); Shiwei GAO, Nepean (CA); Siva MURUGANATHAN, Stittsville (CA)

(21) Appl. No.: 18/844,177

(22) PCT Filed: Mar. 10, 2023
(86) PCT No.: PCT/IB2023/052330

§ 371 Date: Sep. 5, 2024

Related U.S. Application Data
(60) Provisional application No. 63/318,834, filed on Mar. 11, 2022.

(51) Int. Cl. H04B 7/0456; H04B 7/06; H04W 24/10

(52) U.S. Cl. CPC H04B 7/0456; H04B 7/0626; H04W 24/10

(57) ABSTRACT

A method, system and apparatus for Type II precoder matrix indicator (PMI) for coherent joint transmission (CJT) are disclosed. According to one aspect, a method in a network node includes receiving from the wireless device (WD) a precoding matrix indicator (PMI), for coherent joint data transmission over a plurality of transmission reception points (TRPs) and one or both of a time difference and a phase slope associated with each TRP of the plurality of TRPs relative to a reference timing. The method also includes applying a time pre-compensation to a physical downlink channel at each of the plurality of TRPs according to at least one of the time difference and the phase slope associated with the TRP. The method also includes applying a precoding matrix indicated by the PMI to the physical downlink channel at each of the plurality of TRPs.

### FIELD

The present disclosure relates to wireless communications, and in particular, to precoder matrices such as a Type II precoder matrix indicator (PMI) for coherent joint transmission (CJT).

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

### Codebook-Based Precoding

Multi-antenna techniques may significantly increase the data rates and reliability of a wireless communication system. The performance is in particular improved if both the transmitter and the receiver are equipped with multiple antennas, which results in a multiple-input multiple-output (MIMO) communication channel. Such systems and/or related techniques are commonly referred to as MIMO.

The NR standard is currently evolving with enhanced MIMO support. A core component in NR is the support of MIMO antenna deployments and MIMO related techniques such as spatial multiplexing. The spatial multiplexing mode is aimed for high data rates in favorable channel conditions. An illustration of an example of the spatial multiplexing operation is provided in FIG. 1.

As shown in FIG. 1, the information carrying symbol vector s is multiplied by an N_{T}×r precoder matrix W, which serves to distribute the transmit energy in a subspace of the N_{T} (corresponding to N_{T} antenna ports) dimensional vector space. The precoder matrix is typically selected from a codebook of possible precoder matrices, and typically indicated by means of a precoder matrix indicator (PMI), which specifies a unique precoder matrix in the codebook for a given number of symbol streams. Each of the r symbols in s correspond to a layer and r is referred to as the transmission rank. In this way, spatial multiplexing is achieved since multiple symbols may be transmitted simultaneously over the same time/frequency resource element (TFRE). The number of symbols r is typically adapted to suit the current channel properties.

NR uses orthogonal frequency division multiplexing (OFDM) in the downlink and discrete Fourier transform (DFT), pre-coded OFDM in the uplink (for rank-1 transmission). Hence, the received N^{R}×1 vector yₙ for a certain TFRE on subcarrier n (or alternatively data TFRE number n) can be modeled by:

yₙ=HₙWsₙ+eₙ

where eₙ is a noise/interference vector obtained as realizations of a random process. The precoder W may be a wideband precoder, which is constant over frequency, or may be frequency selective.

The precoder matrix W is often chosen to match the characteristics of the N_{R}×N_{T} MIMO channel matrix Hₙ, resulting in so-called channel dependent precoding. This is also commonly referred to as closed-loop precoding and essentially strives for focusing the transmit energy into a subspace which is strong in the sense of conveying much of the transmitted energy to the WD.

In closed-loop precoding for the NR downlink, the WD transmits recommendations to the network node (for example, a gNB) of a suitable precoder to use based on channel measurements in the downlink. The network node configures the WD to provide feedback according to CSI-ReportConfig and may transmit CSI-RS and configure the WD to use measurements of CSI-RS to feed back recommended precoding matrices that the WD selects from a codebook. A single precoder that is supposed to cover a large bandwidth (wideband precoding) may be fed back. It may also be beneficial to match the frequency variations of the channel and instead feed back a frequency-selective precoding report, e.g., several precoders, one per subband. This is an example of the more general case of channel state information (CSI) feedback, which also encompasses feeding back other information than recommended precoders to assist the network node in subsequent transmissions to the WD. Such other information may include channel quality indicators (CQIs) as well as transmission rank indicator (RI). In NR. CSI feedback may be either wideband, where one CSI is reported for the entire channel bandwidth, or frequency-selective, where one CSI is reported for each subband, where a subband is defined as a number of contiguous resource blocks ranging between 4-32 physical resource blocks (PRBs) depending on the band width part (BWP) size.

Given the CSI feedback from the WD, the network node determines the transmission parameters it wishes to use to transmit to the WD, including the precoding matrix, transmission rank, and modulation and coding scheme (MCS). These transmission parameters may differ from the recommendations the WD makes. The transmission rank, and thus the number of spatially multiplexed layers, is reflected in the number of columns of the precoder W. For efficient performance, a transmission rank that matches the channel properties should be selected.

### 2D Antenna Arrays

Two-dimensional antenna arrays may be characterized in part by the number of antenna columns corresponding to the horizontal dimension Nₕ, the number of antenna rows corresponding to the vertical dimension Nᵥ and the number of dimensions corresponding to different polarizations Nₚ. The total number of antennas is thus N=NₕNᵥNₚ. The concept of an antenna is non-limiting in the sense that it may refer to any virtualization (e.g., linear mapping) of the physical antenna elements. For example, pairs of physical sub-elements could be fed the same signal, and hence share the same virtualized antenna port.

An example of a 4×4 array with dual-polarized antenna elements is illustrated in FIG. 2.

Precoding may be interpreted as multiplying the signal with different beamforming weights for each antenna prior to transmission. A typical approach is to tailor the precoder to the antenna form factor, i.e., taking into account Nₕ, Nᵥ and Nₚ when designing the precoder codebook.

### Channel State Information Reference Signals (CSI-RS)

For CSI measurement and feedback, CSI-reference signals (RS) are defined. A CSI-RS is transmitted on each antenna port and is used by a WD to measure the downlink channel between each of the transmit antenna ports and each of its receive antenna ports. The transmit antenna ports are also referred to as CSI-RS ports. The supported number of antenna ports in NR are {1, 2, 4, 8, 12, 16, 24, 32}. By measuring the received CSI-RS, a WD may estimate the channel that the CSI-RS is traversing, including the radio propagation channel and antenna gains. The CSI-RS for the above purpose is also referred to as Non-Zero Power (NZP) CSI-RS.

CSI-RS may be configured to be transmitted in certain REs in a slot and certain slots. FIG. 3 shows an example of CSI-RS REs for 12 antenna ports, where 1 RE per RB per port is shown.

In addition, an interference measurement resource (IMR) is also defined in NR for a WD to measure interference. An IMR resource contains 4 resource elements (REs), either 4 adjacent RE in frequency in the same OFDM symbol or a 2 by 2 block of adjacent REs in both time and frequency in a slot. By measuring both the channel based on non-zero power (NZP) CSI-RS and the interference based on an IMR, a WD may estimate the effective channel and noise plus interference to determine the CSI, (i.e., rank, precoding matrix, and the channel quality).

Furthermore, a WD in NR may be configured to measure interference based on one or multiple NZP CSI-RS resources.

### CSI Framework in NR

In NR, a WD may be configured with multiple CSI reporting settings and multiple CSI-RS resource settings. Each resource setting may contain multiple resource sets, and each resource set may contain up to 8 CSI-RS resources. For each CSI reporting setting, a WD feeds back a CSI report.

Each CSI reporting setting contains at least the following information:
A CSI-RS resource set for channel measurement;
An IMR resource set for interference measurement;
Optionally, a CSI-RS resource set for interference measurement;
Time-domain behavior, (i.e., periodic, semi-persistent, or aperiodic reporting);
Frequency granularity, i.e., wideband or subband;
CSI parameters to be reported such as rank indicator (RI), precoding matrix indicator (PMI), channel quality indicator (CQI), and CSI-RS resource indicator (CRI) in case of multiple CSI-RS resources in a resource set;
Codebook types, i.e., type I or II, and codebook subset restriction;
Measurement restrictions; and
Subband size. One out of two possible subband sizes is indicated, the value range depending on the bandwidth of the BWP. One CQI/PMI (if configured for subband reporting) is fed back per subband).

### DFT-Based Precoders

A common type of precoding is to use a DFT-precoder, where the precoder vector used to precode a single-layer transmission using a single-polarized uniform linear array (ULA) with N antennas is defined as:

$${w}_{1 D} ( k ) = \frac{1}{\sqrt{N}} [ \begin{matrix}{e}^{j 2 π \cdot 0 \cdot \frac{k}{QN}} \\ {e}^{j 2 π \cdot 1 \cdot \frac{k}{QN}} \\ ⋮ \\ {e}^{j 2 π \cdot ( N - 1 ) \cdot \frac{k}{QN}}\end{matrix} ] ,$$

where k=0, 1, . . . . QN−1 is the precoder index and Q is an integer oversampling factor. A corresponding precoder vector for a two-dimensional uniform planar array (UPA) may be created by taking the Kronecker product of two precoder vectors as follows:

$${w}_{2 D} ( k , l ) = {w}_{1 D} ( k ) ⊗ {w}_{1 D} ( l ) .$$

Extending the precoder for a dual-polarized UPA may then be done as follows:

$${w}_{2 D , DP} ( k , l , ϕ ) =$$

$$[ \begin{matrix}1 \\ {e}^{j ϕ}\end{matrix} ] ⊗ {w}_{2 D} ( k , l ) = [ \begin{matrix}{w}_{2 D} ( k , l ) \\ {e}^{j ϕ} {w}_{2 D} ( k , l )\end{matrix} ] = [ \begin{matrix}{w}_{2 D} ( k , l ) & 0 \\ 0 & {w}_{2 D} ( k , l )\end{matrix} ] [ \begin{matrix}1 \\ {e}^{j ϕ}\end{matrix} ] ,$$

where e^{jϕ} is a co-phasing factor that may be selected from a quadrature phase shift keying (QPSK) alphabet ϕ∈{0,π/2,π,3π/2}.

A precoder matrix W_{2D,DP} for multi-layer transmission may be created by appending columns of DFT precoder vectors as follows:

$${w}_{2 D , DP} = [ \begin{matrix}{w}_{2 D , DP} ( {k}_{1} , {l}_{1} , {ϕ}_{1} ) & {w}_{2 D , DP} ( {k}_{2} , {l}_{2} , {ϕ}_{2} ) & … & {w}_{2 D , DP} ( {k}_{R} , {l}_{R} , {ϕ}_{R} )\end{matrix} ] ,$$

where R is the number of transmission layers, (transmission rank). In a common special case, for a rank-2 DFT precoder, k₁=k₂=k and l₁=l₂=1, meaning that:

$${w}_{2 D , DP} =$$

$$[ \begin{matrix}{w}_{2 D , DP} ( k , l , {ϕ}_{1} ) & {w}_{2 D , DP} ( k , l , {ϕ}_{2} )\end{matrix} ] = [ \begin{matrix}{w}_{2 D} ( k , l ) & 0 \\ 0 & {w}_{2 D} ( k , l )\end{matrix} ] [ \begin{matrix}1 & 1 \\ {e}^{j {ϕ}_{1}} & {e}^{j {ϕ}_{2}}\end{matrix} ] .$$

Such DFT-based precoders are used in NR Type I CSI feedback.

### MU-MIMO

With multi-user MIMO (MU-MIMO), two or more users in the same cell are co-scheduled on the same time-frequency resource. That is, two or more independent data streams are transmitted to different WDs at the same time, and the spatial domain (SD) is used to separate the respective streams. By transmitting several streams simultaneously, the capacity of the system may be increased. However, this comes at the cost of reducing the signal to interference plus noise ratio (SINR) per stream, as the power must be shared between streams, and the streams will interfere.

### NR Rel-15 Type II Codebook

For the NR Type II codebook in 3GPP Technical Release 15 (3GPP Rel-15), the precoding vector for each layer and subband is expressed in 3GPP Technical Standard (TS) 38.214 as:

$${w}_{{q}_{1} , {q}_{2} , {n}_{1} , {n}_{2} , {p}_{l}^{( 1 )} , {p}_{l}^{( 2 )} , {c}_{l}}^{l} = \frac{1}{\sqrt{{N}_{1} {N}_{2} {\sum }_{i = 0}^{2 L - 1} {( {p}_{l , i}^{( 1 )} {p}_{l , i}^{( 2 )} )}^{2}}} [ \begin{matrix}{\sum }_{i = 0}^{L - 1} {v}_{{m}_{1}^{( i )} , {m}_{2}^{( i )}} {p}_{l , i}^{( 1 )} {p}_{l , i}^{( 2 )} {φ}_{l , i} \\ {\sum }_{i = 0}^{L - 1} {v}_{{m}_{1}^{( i )} , {m}_{2}^{( i )}} {p}_{l , i + L}^{( 1 )} {p}_{l , i + L}^{( 2 )} {φ}_{l , i + L}\end{matrix} ] , l = 1 , 2$$

If this is restructured and expressed more simply, the precoder vector w_{l,p}(k) for a certain layer l=0,1, polarization p=0,1 and resource block k=0, . . . , N_{RB}−1 may be expressed as:

$${w}_{l , p} ( k ) = \frac{1}{C} {\sum }_{i = 0}^{L - 1} {v}_{i} {p}_{l , i}^{( 1 )} {c}_{l , i} ( k )$$

where c_{l,i}(k)=p_{l,i}⁽²⁾(|k/S|)φ_{l,i}(|k/S|) for p=0 and c_{l,i}(k)=p_{l,L+i}⁽²⁾ (|k/S|)φ_{l,L+i}(|k/S|) for p=1, S is the subband size and N_{SB} is the number of subbands in the CSI reporting bandwidth. Hence, the change in a beam coefficient across frequency c_{l,i}(k) is determined based on the 2N_{SB} parameters p_{l,i}⁽²⁾(0), . . . , p_{l,i}⁽²⁾(N_{SB}−1) and φ_{l,i}(0), . . . , φ_{l,i}(N_{SB}−1). Where the subband amplitude parameter p_{l,i}⁽²⁾ is quantized using 0-1 bit and the subband phase parameter φ_{l,i} is quantized using 2 or 3 bits, depending on codebook configuration.

### NR 3GPP Rel-16 Enhanced Type II Port Selection Codebook

The enhanced Type II (eType II) port selection (PS) codebook was introduced in 3GPP Rel-16, which is intended to be used for beamformed CSI-RS, where each CSI-RS port covers a small portion of the cell coverage area with high beamforming gain (comparing to non-beamformed CSI-RS). Although it is up to the network node 16, e.g., gNB, implementation, it is usually assumed that each CSI-RS port is transmitted in a 2D spatial beam which has a main lobe with an azimuth pointing angle and an elevation pointing angle. The actual precoder matrix used for CSI-RS is transparent to the WD. Based on the measurement, the WD selects the best CSI-RS ports and recommends a rank, a precoding matrix, and a CQI conditioned on the rank and the precoding matrix to the network node to use for downlink (DL) transmission. The precoding matrix comprises linear combinations of the selected CSI-RS ports. The eType II PS codebook may be used by the WD to feedback the selected CSI-RS ports and the combining coefficients.

Structure, Configuration and Reporting of eType II PS Codebook

For a given transmission layer l, with l∈{1, . . . , v} and v being the rank indicated by the rank indicator (RI), the precoder matrix is given by a size P_{CSI-RS}×N₃ matrix Wₗ, where:
P_{CSI-RS} is the number of CSI-RS ports;
N₃=N_{SB}×R is the number of subbands for PMI, where:
   The value R={1,2} (the PMI subband size indicator) is radio resource control (RRC) configured;
   N_{SB} is the number of CQI subbands, which is also RRC configured; and
   The maximum RI value v is set according to the configured higher layer parameter typeII-RI-Restriction-r16. The WD shall not report v>4.

For each layer l, the precoding matrix W^{l} may be factorized as W^{l}=W₁W_{2,l}W_{f,l}^{H} (as shown in FIG. 4) and W^{l}=[w_{0,l}, w_{1,l}, . . . , w_{N}_{₃}_{-1,l}] is normalized such that ∥w_{t,l}∥_{F}=1/\sqrt{v}, for l=1, . . . , v and t=0, 1, . . . , N₃−1.

Port selection matrix W₁:

W₁ is a size P_{CSI-RS}×2L port selection precoder matrix that may be factorized into

$${W}_{1} = [ \begin{matrix}1 & 0 \\ 0 & 1\end{matrix} ] ⊗ {W}_{PS} ,$$

where ⊗ denotes Kronecker product and W_{PS}=[w₁⁽⁰⁾ . . . w₁^{(L-1)}] is a size

$$\frac{{P}_{CSI - RS}}{2} \times L$$

port selection matrix, where w₁⁽ⁱ⁾ of size

$$\frac{{P}_{CSI - RS}}{2} \times 1 ,$$

for i=0, 1, . . . , L−1, contains one element that indicates the selected CSI-RS port while all the other elements are 0s. L is the number of selected CSI-RS ports from each polarization and the same ports are selected for both polarizations:
Supported L values may be found in Table;
Selected CSI-RS ports are indicated by

$${i}_{1 , 1} ∈ \{ 0 , 1 , … , ⌈ \frac{{P}_{CSI - RS}}{2 d} ⌉ - 1 \} ,$$

which is reported by the WD to network node:
The value of i_{1,1} is determined by WD based on CSI-RS measurement;
The value of d is configured with the higher layer parameter portSelectionSamplingSize, where d∈{1, 2, 3, 4} and

$$d < min ( \frac{{P}_{CSI - RS}}{2} , L ) ;$$

W₁ is common for all layers.

Frequency-domain (FD) compression matrix W_{f,l}:

W_{f,l} is a size N₃×Mᵥ FD compression matrix for layer l, where

$${M}_{v} = ⌈ {p}_{v} \frac{{N}_{3}}{R} ⌉$$

is the number of selected FD basis vectors, which depends on the rank indicator v and the RRC configured parameter pᵥ. Supported values of pᵥ may be found in Table.

$${W}_{f , l} = [ \begin{matrix}{w}_{f , l}^{( 0 )} & … & {w}_{f , l}^{( {M}_{v} - 1 )}\end{matrix} ] , where {\{ {w}_{f , l}^{( k )} \}}_{k = 0}^{{M}_{v} - 1}$$

are Mᵥ FD basis vectors that are selected from N₃ orthogonal DFT basis vectors {fₜ}ₜ₌₀^{N}^{₃}⁻¹, where

$${f}_{t} = {[ \begin{matrix}1 & {e}^{\frac{j 2 π t}{{N}_{3}}} , & … , & {e}^{\frac{j 2 π ( {N}_{3} - 1 ) t}{{N}_{3}}}\end{matrix} ]}^{T} ,$$

(⋅)^{T} denotes transpose:
For N₃≤19, a one-step free selection is used:
For each layer, FD basis selection is indicated with a

$$⌈ {log}_{2} ( \begin{matrix}{N}_{3} - 1 \\ {M}_{v} - 1\end{matrix} ) ⌉$$

bit combinatorial indicator. In TS 38.214, the combinatorial indicator is given by the index i_{1,6,l} where l corresponds to the layer index. This combinatorial index is reported by WD to the network node per layer;
For N₃>19, a two-step selection with layer-common intermediary subset (IntS) is used:
In this first step, a window-based layer-common IntS selection is used, which is parameterized by Mᵢₙᵢₜᵢₐₗ. The IntS consists of FD basis vectors mod(Mᵢₙᵢₜᵢₐₗ+n, N₃), where n=0, 1, . . . , N₃′−1 and N₃′=2Mᵥ. In TS 38.214, the selected IntS is reported by the WD to the network node via the parameter i_{1,5}, which is reported per layer as part of the PMI reported;
The second step subset selection is indicated by an

$$⌈ {log}_{2} ( \begin{matrix}{N}_{3}^{′} - 1 \\ {M}_{v} - 1\end{matrix} ) ⌉$$

combinatorial indicator for each layer. In 3GPP TS 38.214, the combinatorial indicator is given by the index i_{1,6,l} where l corresponds to the layer index. This combinatorial index is reported by WD to the network node per layer;
W_{f,l} is layer-specific.

Linear combination coefficient matrix W_{2,i}:
W_{2,l} is a size 2L×Mᵥ matrix that contains 2LMᵥ coefficients for linearly combining the selected Mᵥ FD basis vectors and the selected 2L CSI-RS ports;
For layer l, only a subset of Kₗ^{NZ}≤K₀ coefficients are non-zero and reported. The remaining 2LMᵥ−Kₗ^{NZ} non-reported coefficients are considered zero;
K₀=┌β×2LM₁┐ is the maximum number of non-zero coefficients per layer, where β is a RRC configured parameter. Supported β values are shown in Table 1;
For v∈{2, 3, 4}, the total number of non-zero coefficients summed across all layers, Kₜₒₜ^{NZ}=Σₗ₌₁^{v}Kₗ^{NZ}, shall satisfy Kₜₒₜ^{NZ}≤2K₀;
Selected coefficient subset for each layer is indicated with Kₗ^{NZ} 1 s in a size 2LMᵥ bitmap, i_{1,7,l};
The selected CSI-RS port associated with the strongest coefficient of layer l is identified by i_{1,8,l},∈{0, 1, . . . , 2L−1};
The amplitude coefficients in W_{2,l} are indicated by i_{2,3,l} and i_{2,4,l}, and the phase coefficients in W_{2,l} are indicated by i_{2,5,l}; and/or
W_{2,l} is layer-specific.

TABLE 1
3GPP Rel-16 Type II PS codebook parameter
configurations for L, p_{ν} and β

| | | Pν | | |
|---|---|---|---|---|
| paramCombination- | | ν | ν ϵ | |
| r16 | L | ϵ {1, 2} | {3, 4} | β |
| 1 | 2 | ¼ | 1/8 | ¼ |
| 2 | 2 | ¼ | 1/8 | ½ |
| 3 | 4 | ¼ | 1/8 | ¼ |
| 4 | 4 | ¼ | 1/8 | ½ |
| 5 | 4 | ¼ | ¼ | ¾ |
| 6 | 4 | ½ | ¼ | ½ |

The PMI reported by the WD includes codebook indices i₁ and i₂ where

$${i}_{1} = \{ \begin{matrix}[ \begin{matrix}{i}_{1 , 1} & {i}_{1 , 5} & {i}_{1 , 6 , 1} & {i}_{1 , 8 , 1}\end{matrix} ] & v = 1 \\ [ \begin{matrix}{i}_{1 , 1} & {i}_{1 , 5} & {i}_{1 , 6 , 1} & {i}_{1 , 7 , 1} & {i}_{1 , 8 , 1} & {i}_{1 , 6 , 2} & {i}_{1 , 7 , 2} & {i}_{1 , 8 , 2}\end{matrix} ] & v = 2 \\ [ \begin{matrix}{i}_{1 , 1} & {i}_{1 , 5} & {i}_{1 , 6 , 1} & {i}_{1 , 7 , 1} & {i}_{1 , 8 , 1} & {i}_{1 , 6 , 2} & {i}_{1 , 7 , 2} & {i}_{1 , 8 , 2} & {i}_{1 , 6 , 3} & {i}_{1 , 7 , 3} & {i}_{1 , 8 , 3}\end{matrix} ] & v = 3 \\ [ \begin{matrix}{i}_{1 , 1} & {i}_{1 , 5} & {i}_{1 , 6 , 1} & {i}_{1 , 7 , 1} & {i}_{1 , 8 , 1} & {i}_{1 , 6 , 2} & {i}_{1 , 7 , 2} & {i}_{1 , 8 , 2} & {i}_{1 , 6 , 3} & {i}_{1 , 7 , 3} & {i}_{1 , 8 , 3} & {i}_{1 , 6 , 4} & {i}_{1 , 7 , 4} & {i}_{1 , 8 , 4}\end{matrix} ] & v = 4\end{matrix} \\ {i}_{2} = \{ \begin{matrix}[ \begin{matrix}{i}_{2 , 3 , 1} & {i}_{2 , 4 , 1} & {i}_{2 , 5 , 1}\end{matrix} ] & v = 1 \\ [ \begin{matrix}{i}_{2 , 3 , 1} & {i}_{2 , 4 , 1} & {i}_{2 , 5 , 1} & {i}_{2 , 3 , 2} & {i}_{2 , 4 , 2} & {i}_{2 , 5 , 2}\end{matrix} ] & v = 2 \\ [ \begin{matrix}{i}_{2 , 3 , 1} & {i}_{2 , 4 , 1} & {i}_{2 , 5 , 1} & {i}_{2 , 3 , 2} & {i}_{2 , 4 , 2} & {i}_{2 , 5 , 2} & {i}_{2 , 3 , 3} & {i}_{2 , 4 , 3} & {i}_{2 , 5 , 3}\end{matrix} ] & v = 3 \\ [ \begin{matrix}{i}_{2 , 3 , 1} & {i}_{2 , 4 , 1} & {i}_{2 , 5 , 1} & {i}_{2 , 3 , 2} & {i}_{2 , 4 , 2} & {i}_{2 , 5 , 2} & {i}_{2 , 3 , 3} & {i}_{2 , 4 , 3} & {i}_{2 , 5 , 3} & {i}_{2 , 3 , 4} & {i}_{2 , 4 , 4} & {i}_{2 , 5 , 4}\end{matrix} ] & v = 4\end{matrix}$$

The precoding matrix is the PMI values according to Table 2.

TABLE 2
Precoding matrix indicated by PMI.

| Numbers | Precoding Matrix for PMI |
|---|---|
| of layers | subband t ϵ (0, 1, . . . , N₃) |
| ν = 1 | Wₜ^{(ν=1)} = W_{1, t} |
| ν = 2 | Wₜ^{(ν=2)} = [W_{1, t} W_{2, t}] |
| ν = 3 | Wₜ^{(ν=3)} = [W_{1, t} W_{2, t} W_{3, t}] |
| ν = 4 | Wₜ^{(ν=4)} = [W_{1, t} W_{2, t} W_{3, t} W_{4, t}] |

where:

$${w}_{l , t} = \frac{1}{\sqrt[2]{v}} \frac{1}{\sqrt[2]{{γ}_{t , l}}} [ \begin{matrix}{\sum }_{i = 0}^{L - 1} {v}_{{i}_{1 , 1} d + i} {p}_{l , 0}^{( 1 )} {\sum }_{f = 0}^{{M}_{v} - 1} {y}_{t , l}^{( f )} {p}_{l , i , f}^{( 2 )} {φ}_{l , i , f} \\ {\sum }_{i = 0}^{L - 1} {v}_{{i}_{1 , 1} d + i} {p}_{l , 1}^{( 1 )} {\sum }_{f = 0}^{{M}_{v} - 1} {y}_{t , l}^{( f )} {p}_{l , i + L , f}^{( 2 )} {φ}_{l , i + L , f}\end{matrix} ] , \\ l = 1 , 2 , 3 , 4 ; t = 0 , 1 , … , {N}_{3} - 1 ; \\ {γ}_{t , l} = {\sum }_{i = 0}^{2 L - 1} {( {p}_{l , ⌊ \frac{i}{L} ⌋}^{( 1 )} )}^{2} {\vert {\sum }_{f = 0}^{{M}_{v} - 1} {y}_{t , l}^{( f )} {p}_{l , i , f}^{( 2 )} {φ}_{l , i , f} \vert}^{2} ;$$

vₘ is a P_{CSI-RS}/2-element column vector containing a value of 1 in element (m mod P_{CSI-RS}/2) and zeros elsewhere;

$${y}_{t , l}^{( f )} = {e}^{j \frac{2 π {tn}_{3 , l}^{( f )}}{{N}_{3}}} , t = 0 , 1 , … , {N}_{3} - 1 ; f = 0 , 1 , … , {M}_{v} - 1 ; l = 1 , 2 , 3 , 4 ; \\ {n}_{3 , l}^{( f )} ∈ ( 0 , 1 , … , {N}_{3} - 1 ) is derived from {i}_{1 , 6 , l} and if {N}_{3} > 19 , {i}_{1 , 5} ;$$

p_{l,p}⁽¹⁾, p∈(0,1) is a wideband amplitude coefficient indicated by i_{2,3,l};
p_{l,i,f}⁽²⁾ is a subband amplitude coefficient indicated by i_{2,4,l}; and

$${φ}_{l , i , f} = {e}^{j \frac{2 π {c}_{l , i , f}}{16}} ,$$

c_{l,i,f}∈{0, . . . , 15} is phase coefficient indicated by i_{2,5,l}.

For 3GPP Rel-16 Enhanced Type II CSI feedback, a CSI report includes two parts. Part 1 has a fixed payload size and is used to identify the number of information bits in Part 2. Part 1 contains RI, CQI, and an indication of the overall number of non-zero amplitude coefficients across layers, i.e., Kₜₒₜ^{NZ}∈{1, 2, . . . , 2K₀}. Part 2 contains the PMI. Part 1 and 2 are separately encoded.

### FDD-Based Reciprocity Operation and 3GPP Rel-17 Type II Port Selection Codebook

In frequency division duplex (FDD) operation, the uplink (UL) and DL transmissions are carried out on different frequencies. Thus, the propagation channels in UL and DL are not reciprocal as in the time division duplex (TDD) case. Despite this, some physical channel parameters, e.g., delays and angles to different clusters, which depend on the spatial properties of the channel but not the carrier frequency, are reciprocal between UL and DL. Such properties may be exploited to obtain partial reciprocity based FDD transmission. The reciprocal part of the channel may be combined with the non-reciprocal part in order to obtain the complete channel. An estimate of the non-reciprocal part may be obtained by feedback from the WD. In 3GPP RAN1, it has been considered that in 3GPP Rel-17, the 3GPP Rel-16 Type II port selection codebook will be enhanced to support the above the above-mentioned FDD-based reciprocity operation. It has been considered in 3GPP RAN1 #104e that the 3GPP Rel-17 Type II port selection codebook will adopt the same codebook structure as the 3GPP Rel-16 Type II port selection codebook, i.e., the codebook consists of W₁, W₂, and W_{f}. Consideration of details of the codebook component, such as dimension of each matrix, is still ongoing.

### Procedure for FDD-Based Reciprocity Operation

One example procedure for reciprocity based FDD transmission scheme is illustrated in FIG. 5 in 4 steps, assuming that NR 3GPP Rel-16 enhanced Type II port-selection codebook is used.

In Step 1, the WD is configured with a sounding reference signal (SRS) by the network node and the WD transmits SRS in the UL for the network node to estimate the angles and delays of different clusters, which are associated with different propagation paths.

In Step 2, the network node selects dominant clusters according to the estimated angle-delay power spectrum profile, based on which a set of spatial-domain and frequency-domain (SD-FD) basis pairs are computed by the network node for CSI-RS beamforming. Each SD-FD pair corresponds to a CSI-RS port with certain delay being pre-compensated. Each CSI-RS port resource may contain one or multiple SD-FD basis pairs by applying different delays on different resource elements of the resource. The network node precodes all the CSI-RS ports in a configured CSI-RS resource or multiple CSI-RS resources to the WD, with each configured CSI-RS resource containing the same number of SD-FD basis pairs.

In Step 3, the network node has configured the WD to measure CSI-RS, and the WD measures the received CSI-RS ports and then determines a type II CSI including RI, PMI for each layer and CQI. The precoding matrix indicated by the PMI includes the selected SD-FD basis pairs/precoded CSI-RS ports, and the corresponding best phase and amplitude for co-phasing the selected pairs/ports. The phase and amplitude for each pair/port are quantized and fed back to the network node.

In Step 4, the network node implementation algorithm computes the DL precoding matrix per layer based on the selected beams and the corresponding amplitude and phase feedback and performs PDSCH transmission. The transmission is based on the feed-back (PMI) precoding matrices directly (e.g., SU-MIMO transmission) or the transmission precoding matrix is obtained from an algorithm combining CSI feedback from multiple WDs (MU-MIMO transmission). In this case, a precoder derived based on the precoding matrices (including the CSI reports from co-scheduled WDs) (e.g., Zero-Forcing precoder or regularized ZF precoder). The final precoder is commonly scaled so that the transmit power per power amplifier is not overridden.

Such reciprocity-based transmission may potentially be utilized in a codebook-based DL transmission for FDD in order to, for example, reduce the feedback overhead in UL when NR Type II port-selection codebook is used. Another potential benefit is reduced complexity in the CSI calculation in the WD.

Note that FIG. 5 shows only one example of the procedure for FDD-based reciprocity operation, where each CSI-RS port contains a single pair of SD-FD basis and the WD performs wideband averaging of the channel to obtain the corresponding coefficients. It is possible that each CSI-RS port contains multiple pairs of SD-FD basis and that it is possible that the WD may compress the channel with more FD components besides the DC DFT component.

### Type II Port Selection Codebook for FDD Operation Based on Angle and Delay Reciprocity

If the 3GPP Rel-16 enhanced Type II port-selection codebook is used for FDD operation based on angle and/or delay reciprocity, the frequency-domain (FD) basis W_{f} still needs to be determined by the WD. Therefore, in the CSI report, the feedback overhead for indicating which FD basis vectors are selected may be large. This is especially true when N₃, the number of PMI subbands, is large. Also, the computational complexity at the WD for evaluating and selecting the best FD basis vectors also increases as N₃ increases. In addition, the channel seen at the WD is frequency-selective, which requires a number of FD basis vectors to compress in the PMI report. Reporting coefficients to these FD basis vectors also consumes a large amount of UL overhead.

Based on the angle and delay reciprocity, the network node may determine a set of dominant clusters in the propagation channel by analyzing the angle-delay power spectrum of the UL channel. Then, the network node may utilize this information in a way such that each CSI-RS port is precoded towards a dominant cluster. In addition to SD beamforming, each of the CSI-RS ports will also be pre-compensated in time such that all the precoded CSI-RS ports are aligned in delay domain. As a result, frequency-selectivity of the channel is removed and the WD observes a frequency-flat channel, which requires a very small number of FD basis to compress. Ideally, if all the beams may be perfectly aligned in time, the WD only needs to do a wideband filtering to obtain all the channel information, based on which the WD may calculate the 3GPP Rel-17 Type II PMI. Even if delay cannot be perfectly pre-compensated at the network node in reality, the frequency selectively seen at the WD may still be greatly reduced, so that the WD only requires a much smaller number of FD basis vectors, i.e., the number of basis vectors in W_{f}, to compress the channel.

The above procedure is further explained with defence to the example of FIG. 6. Based on UL measurements, the network node identifies 8 dominant clusters that exist in the original channel, tagged as A-G, which are distributed in 4 directions, with each direction containing one or multiple taps. In this example, 8 CSI-RS ports are precoded at the network node. Each CSI-RS port is precoded towards a dominant direction with pre-compensated delay for a given clusters. The delay compensation may be realized in different ways, for instance by applying a linear phase slope across occupied subcarriers. As a result, in the beamformed channel, which is seen at the WD, all the dominant clusters are aligned at the same delay. Hence, the WD only needs to apply a wideband filter (e.g., applying the DC component of a DFT matrix. (i.e., W_{f} containing a single all one vector over frequency domain channel) to compress the channel and preserve all the channel information. Based on the compressed channel, the WD calculates W₁ (selected CSI-RS ports) and W₂ (complex coefficients for combining selected ports), which are the remaining part of the Type II port selection codebook.

The 3GPP Rel-17 Type II precoder follows the same structure as the 3GPP Rel-16 Type II ports-selection codebook, i.e., the 3GPP Rel-17 also includes W₁, W₂ and W_{f}. One difference between the 3GPP Rel-17 Type II precoder and the 3GPP Rel-16 Type II codebook is that W_{f} is layer-common, and the number of FD basis vectors may only be 1 or 2.

PDSCH Transmission from Multiple TRPs

In NR 3GPP Rel-16, non-coherent joint physical downlink shared channel (PDSCH) transmission from two transmission and reception points (TRPs) was introduced in which a subset of MIMO layers of a PDCCH to a WD are transmitted from a first TRP and the rest of layers of the PDSCH are transmitted from a second TRP in the same time and frequency resource. Different layers are separated and received at the WD with a MIMO capable receiver.

An example is shown in FIG. 7, where a physical downlink shared channel (PDSCH) with two layers are scheduled with the first layer transmitted from TRP1 and the second layer from TRP2. This is signaled in the corresponding downlink control information (DCI) by indicating a TCI codepoint associated with two TCI states, a first and second TCI state, and DMRS ports x and y in two CDM groups. Here, demodulation reference signal (DMRS) port x in the first CDM group is associated with the first TCI state and DMRS port y in the second CDM group is associated with the second TCI state. The first TCI state may contain TRS1 (tracking reference signal 1) as the quasi-collocated (QCL) source RS and the second TCI state may contain TRS1 as the QCL source RS.

### SFN PDSCH

In NR 3GPP Rel-17, enhanced single frequency network (SFN) based PDSCH was also introduced for more robust PDSCH reception in which a PDSCH is transmitted simultaneously from two TRPs in a same time and frequency resource.

An example is shown in FIG. 8, where the same PDSCH together with its DMRS is transmitted from both TRPs. This is indicated to a WD by both a RRC configuration of system frame number (SFN) PDSCH and two transmission configuration indicator (TCI) states indicated in a DCI scheduling the PDSCH. The first TCI state may contain TRS1 as the QCL source RS and the second TCI state may contain TRS2 as the QCL source RS. The DMRS is now associated with the two TCI states because the DMRS is transmitted from both TRPs.

### SUMMARY

Some embodiments advantageously provide methods, network nodes and wireless devices for Type II precoder matrix indicator (PMI) for coherent joint transmission (CJT).

In some embodiments, for coherent joint transmission (CJT), the WD receives downlink data that is coherently transmitted from by multiple TRPs. In this case, the delay spread seen by a WD for a channel/signal that is transmitted from multiple TRPs via CJT may be much larger compared to the delay spread when the WD receives a channel/signal transmitted from a single TRP. This is because the multiple TRPs may be geometrically separated, which introduces additional propagation delays which add to the delay spread between the WD and each individual TRP. Hence, the delay spread will increase with the number of TRPs and with their relative geometrical distance.

This increase in observed delay spread by the WD for channels and signals transmitted by multiple TRPs via CJT is further illustrated in FIG. 9.

FIG. 9 is an example of the antenna-delay domain power spectrum of a WD receiving a coherent joint transmission channel/signal from two TRPs, “TRP 1” and “TRP 2”, each with 32 antenna elements. On the y-axis the antenna elements numbered from “1” to “32” belong “TRP 2” while the antenna elements numbered from “33” to “64” belong to “TRP 1”. On the x-axis, the delay taps that represent the normalized propagation delays at the WD corresponding to the different antenna elements are represented. The shading in FIG. 9 represents power for each specific antenna element at a specific delay tap. Most of the power of the antenna elements associated to “TRP 1” is allocated in the first 10 delay taps while most of the power of the antenna elements associated to “TRP 2” is allocated from delay tap “65” to delay tap “75.” The distance between these two groups of delays come from the propagation delay between the WD to the two TRPs. The overall delay spread is greatly increased with the introduction of the second TRP. In this example the delay spread if only “TRP 1” is considered is approximatively 20 delay taps while if “TRP 2” is also considered, this will increase the delay spread to approximatively 80 delay taps.

One approach is to use the NR Type II PMI feedback for multi-TRP scenarios with coherent joint transmission, where the coherence between the TRPs may be implicitly reported via the linear combining coefficients, but this requires use of a high number of Frequency Domain (FD) bases to be able to correctly estimated all the propagation delays. This would produce a very large CSI reporting overhead that would quickly increase with the number of TRPs and the geometrical distance of these that would create a higher delay spread, as explained above.

When the WD is served by multiple TRPs that are geographically separated, the total delay spread of the combined channel is contributed by the inter-TRP delay spread, which is caused by the different distances between the WD and the TRPs, and the intra-TRP delay spread, which is caused by the multi-path propagation environment. In some embodiments the inter-TRP delay spread from corresponding TRPs is estimated and removed to get an effective channel, based on which a Type II PMI is calculated. The calculated Type II report and the estimated inter-TRP delay spread are jointly reported to the network node, based on which a DL precoder for coherent joint transmission across multiple TRPs are derived.

In some non-limiting embodiments:

One or more of the following may be performed by the WD:
The WD estimates the inter-TRP delay spread, which is the determined by the distance between the WD and the serving TRPs;
The WD calculates an effective DL channel, which is obtained by removing the inter-TRP delay from the DL channel associated with the corresponding TRPs;
The WD calculates a Type II CSI report based on the obtained effective channel; and/or
The WD jointly reports the Type II CSI with the inter-TRP delay spread.

One or more of the following may be performed by the network node:
The network node calculates a DL precoder based on the reported Type II PMI and the inter-TRP delay spread:
   In particular, for each subband, the network node may apply a phase de-rotation for the reported precoder according to the reported inter-TRP delay.

Some embodiments reduce the Type II CSI reporting overhead when it is used for coherent joint transmission with multiple TRPs, while still being to capture the large delay spread in the CSI report.

According to one aspect, a network node configured to communicate with a wireless device. WD via a plurality of transmission and reception points, TRPs is provided. The network node includes: a radio interface configured to receive from the WD a precoding matrix indicator, PMI, for coherent joint data transmission over the plurality of TRPs and one or both of a time difference and a phase slope associated with each TRP of the plurality of TRPs relative to a reference timing; and processing circuitry in communication with the radio interface and configured to: apply a time pre-compensation to a physical downlink channel at each of the plurality of TRPs according to at least one of the time difference and the phase slope associated with the TRP; and apply a precoding matrix indicated by the PMI to the physical downlink channel at each of the plurality of TRPs.

According to this aspect, in some embodiments, the time difference is received as one of a phase change per resource block, RB, a phase change per subcarrier frequency, or a phase change per subband, wherein a subband consists of a number of RBs. In some embodiments, the time pre-compensation to the physical downlink channel is performed by applying a time advance or a time delay on the physical downlink channel according to the time difference. In some embodiments, the time pre-compensation to the physical downlink channel is performed by applying a phase shift per subcarrier, per RB, or per subband in a frequency domain to the physical downlink channel according to the phase slope. In some embodiments, the PMI comprises at least an indicator of a plurality of one or both of spatial beams and spatial domain, SD, basis vectors associated to each of the plurality of TRPs, and an indicator of at least one of frequency domain. FD, basis vectors and co-phasing coefficients each associated to one of the plurality of spatial beams or SD basis vectors associated to each of the plurality of TRPs and to one of the one or more FD basis vectors. In some embodiments, the phase slope is represented by a frequency domain, FD, basis vector, where an index of the FD basis vector is received as part of the PMI. In some embodiments, the reference timing is a downlink timing associated to a reference TRP, wherein the reference TRP is one of the plurality of TRPs. In some embodiments, the reference TRP is at least one of pre-defined and indicated by the WD. In some embodiments, each TRP of the plurality of TRPs is associated with a different channel state information reference signal, CSI-RS, resource.

According to another aspect, a method in a network node configured to communicate with a wireless device, WD, via a plurality of transmission and reception points, TRPs, is provided. The method includes receiving from the WD a precoding matrix indicator, PMI, for coherent joint data transmission over the plurality of TRPs and one or both of a time difference and a phase slope associated with each TRP of the plurality of TRPs relative to a reference timing. The method also includes applying a time pre-compensation to a physical downlink channel at each of the plurality of TRPs according to at least one of the time difference and the phase slope associated with the TRP. The method further includes applying a precoding matrix indicated by the PMI to the physical downlink channel at each of the plurality of TRPs.

According to this aspect, in some embodiments, the time difference is received as one of a phase change per resource block, RB, a phase change per subcarrier frequency, or a phase change per subband, wherein a subband consists of a number of RBs. In some embodiments, the time pre-compensation to the physical downlink channel is performed by applying a time advance or a time delay on the physical downlink channel according to the time difference. In some embodiments, the time pre-compensation to the physical downlink channel is performed by applying a phase shift per subcarrier, per RB, or per subband in a frequency domain to the physical downlink channel according to the phase slope. In some embodiments, the PMI comprises at least an indicator of a plurality of one or both of spatial beams and spatial domain, SD, basis vectors associated to each of the plurality of TRPs, and an indicator of at least one of frequency domain, FD, basis vectors and co-phasing coefficients each associated to one of the plurality of spatial beams or SD basis vectors associated to each of the plurality of TRPs and to one of the one or more FD basis vectors. In some embodiments, the phase slope is represented by a frequency domain, FD, basis vector, where an index of the FD basis vector is received as part of the PMI. In some embodiments, the reference timing is a downlink timing associated to a reference TRP, wherein the reference TRP is one of the plurality of TRPs. In some embodiments, the reference TRP is at least one of pre-defined and indicated by the WD. In some embodiments, each TRP of the plurality of TRPs is associated with a different channel state information reference signal, CSI-RS, resource.

According to yet another aspect, a wireless device, WD, configured to communicate with a network node is provided. The WD includes a radio interface configured to receive, from the network node, a configuration of a channel state information, CSI, report comprising a plurality of downlink CSI reference signal, CSI-RS, resources, wherein each of the plurality of CSI-RS resources represents one of the plurality of TRPs. The WD also includes processing circuitry in communication with the radio interface and configured to: determine based at least in part on measurements of the plurality of downlink CSI-RS resources, for each TRP of the plurality of TRPs, at least one of: a downlink time difference relative to a reference timing; and a downlink phase slope representing a downlink time difference relative to a reference timing. The processing circuitry is also configured to report to the network node, the determined at least one of the downlink time difference and the downlink phase slope associated with each TRP of the plurality of TRPs.

According to this aspect, in some embodiments, the processing circuitry is further configured to: determine, for each of the plurality of TRPs, an effective downlink channel based at least in part on removing an effect of the at least one of the downlink time difference and the downlink phase slope associated to the TRP from a channel measurement performed on a CSI-RS resource associated to the TRP; determine a precoder matrix indicator, PMI, based at least in part on the effective downlink channels for coherent joint data transmission from the plurality of TRPs to the WD; and the radio interface is further configured to transmit, to the network node, the determined PMI. In some embodiments, the PMI indicates a precoding matrix for each of a plurality of subbands, wherein a subband includes a number of resource blocks, RBs. In some embodiments, determining a PMI is based at least in part on the effective downlink channels of the plurality of TRPs. In some embodiments, the PMI includes at least an indicator of a plurality of one or both of spatial beams and spatial domain, SD, discrete Fourier Transform, DFT, basis vectors associated to each of the plurality of TRPs, an indicator of at least one frequency domain, FD, DFT basis vector, and co-phasing coefficients associated to each one of the plurality of one or both of the spatial beams and SD basis vectors associated to each of the plurality of TRPs and at least one of the at least one FD basis vector. In some embodiments, the phase slope associated to each TRP of the plurality of TRPs is reported as a phase change per subband. In some embodiments, the phase slope associated to each TRP of the plurality of TRPs is quantized and represented by a frequency domain, FD, discrete Fourier transform, DFT, basis vector, wherein the FD DFT basis vector is reported for each of the plurality of TRPs as part of the PMI. In some embodiments, the reference timing is a downlink timing acquired by the WD previously based on a downlink reference signal, RS, wherein the downlink RS can be a tracking reference signal, TRS. In some embodiments, the reference timing is a downlink timing associated to a reference TRP, wherein the downlink time difference associated with each TRP is a time delay difference at the WD between a CSI-RS resource associated to the TRP and a CSI-RS resource associated to the reference TRP, and wherein the time difference associated to the reference TRP is zero and is not reported. In some embodiments, the reference TRP is one of the plurality of TRPs. In some embodiments, the reference TRP is explicitly indicated by the network node. In some embodiments, the reference TRP is implicitly indicated by the network node. In some embodiments, the reference TRP is determined by the WD. In some embodiments, the reference TRP is prespecified in specifications. In some embodiments, the radio interface is further configured to transmit to the network node an indication of which TRP of the plurality of TRPs is the reference TRP. In some embodiments, a time difference associated to each of the plurality of TRPs is reported as at least one of a phase change per resource block, RB, and per number of RBs. In some embodiments, determining the effective channel includes removing a delay factor from a channel measurement associated with a TRP of the plurality of TRPs, the delay factor being based at least in part on the time difference between the TRP and the reference TRP.

According to another aspect, a method in a wireless device, WD, configured to communicate with a network node comprising a plurality of transmit and reception points, TRPs, is provided. The method includes receiving, from the network node, a configuration of a channel state information, CSI, report comprising a plurality of downlink CSI reference signal, CSI-RS, resources, wherein each of the plurality of CSI-RS resources represents one of the plurality of TRPs. The method includes determining (S150) based at least in part on measurements of the plurality of downlink CSI-RS resources, for each TRP of the plurality of TRPs, at least one of: a downlink time difference relative to a reference timing; and a downlink phase slope representing a downlink time difference relative to a reference timing. The method also includes reporting, to the network node, the determined at least one of the downlink time difference and the downlink phase slope associated with each TRP of the plurality of TRPs.

According to this aspect, in some embodiments, the processing circuitry is further configured to: determine, for each of the plurality of TRPs, an effective downlink channel based at least in part on removing an effect of the at least one of the downlink time difference and the downlink phase slope associated to the TRP from a channel measurement performed on a CSI-RS resource associated to the TRP; determine a precoder matrix indicator, PMI, based at least in part on the effective downlink channels for coherent joint data transmission from the plurality of TRPs to the WD; and the radio interface is further configured to transmit, to the network node, the determined PMI. In some embodiments, the PMI indicates a precoding matrix for each of a plurality of subbands, wherein a subband includes a number of resource blocks, RBs. In some embodiments, determining a PMI is based at least in part on the effective downlink channels of the plurality of TRPs. In some embodiments, the PMI includes at least an indicator of a plurality of one or both of spatial beams and spatial domain, SD, discrete Fourier Transform, DFT, basis vectors associated to each of the plurality of TRPs, an indicator of at least one frequency domain, FD, DFT basis vector, and co-phasing coefficients associated to each one of the plurality of one or both of the spatial beams and SD basis vectors associated to each of the plurality of TRPs and at least one of the at least one FD basis vector. In some embodiments, the phase slope associated to each TRP of the plurality of TRPs is reported as a phase change per subband. In some embodiments, the phase slope associated to each TRP of the plurality of TRPs is quantized and represented by a frequency domain, FD, discrete Fourier transform, DFT, basis vector, wherein the FD DFT basis vector is reported for each of the plurality of TRPs as part of the PMI. In some embodiments, the reference timing is a downlink timing acquired by the WD previously based on a downlink reference signal, RS, wherein the downlink RS can be a tracking reference signal, TRS. In some embodiments, the reference timing is a downlink timing associated to a reference TRP, wherein the downlink time difference associated with each TRP is a time delay difference at the WD between a CSI-RS resource associated to the TRP and a CSI-RS resource associated to the reference TRP, and wherein the time difference associated to the reference TRP is zero and is not reported. In some embodiments, the reference TRP is one of the plurality of TRPs. In some embodiments, the reference TRP is explicitly indicated by the network node. In some embodiments, the reference TRP is implicitly indicated by the network node. In some embodiments, the reference TRP is determined by the WD. In some embodiments, the reference TRP is prespecified in specifications. In some embodiments, the method includes transmitting to the network node an indication of which TRP of the plurality of TRPs is the reference TRP. In some embodiments, a time difference associated to each of the plurality of TRPs is reported as at least one of a phase change per resource block, RB, and per number of RBs. In some embodiments, determining the effective channel includes removing a delay factor from a channel measurement associated with a TRP of the plurality of TRPs, the delay factor being based at least in part on the time difference between the TRP and the reference TRP.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a transmission structure for precoded spatial multiplexing;

FIG. 2 is a two-dimensional antenna array;

FIG. 3 is an example of resource allocation;

FIG. 4 illustrates matrix factors;

FIG. 5 is a procedure of codebook-based transmission for FDD;

FIG. 6 is an example of CSI-RS precoding;

FIG. 7 is an example of physical downlink control channel (PDCCH) repetition;

FIG. 8 is an example of SFN PDCCH over two TRPs;

FIG. 9 is an antenna delay power spectrum;

FIG. 10 is a schematic diagram of an example network architecture illustrating a communication system connected via an intermediate network to a host computer according to the principles in the present disclosure;

FIG. 11 is a block diagram of a host computer communicating via a network node with a wireless device over an at least partially wireless connection according to some embodiments of the present disclosure;

FIG. 12 is a flowchart illustrating example methods implemented in a communication system including a host computer, a network node and a wireless device for executing a client application at a wireless device according to some embodiments of the present disclosure;

FIG. 13 is a flowchart illustrating example methods implemented in a communication system including a host computer, a network node and a wireless device for receiving user data at a wireless device according to some embodiments of the present disclosure;

FIG. 14 is a flowchart illustrating example methods implemented in a communication system including a host computer, a network node and a wireless device for receiving user data from the wireless device at a host computer according to some embodiments of the present disclosure;

FIG. 15 is a flowchart illustrating example methods implemented in a communication system including a host computer, a network node and a wireless device for receiving user data at a host computer according to some embodiments of the present disclosure;

FIG. 16 is a flowchart of an example process in a network node for Type II precoder matrix indicator (PMI) for coherent joint transmission (CJT);

FIG. 17 is a flowchart of an example process in a wireless device for Type II precoder matrix indicator (PMI) for coherent joint transmission (CJT);

FIG. 18 is a flowchart of another example process in a network node for Type II precoder matrix indicator (PMI) for coherent joint transmission (CJT);

FIG. 19 is a flowchart of another example process in a wireless device for Type II precoder matrix indicator (PMI) for coherent joint transmission (CJT);

FIG. 20 is a multi-TRP channel;

FIG. 21 is an illustration of removing inter-TRP delay;

FIG. 22 is an example of CSI-RS based delay measurement; and

FIG. 23 is an example of applying a precoding matrix with per resource block phase rotation.

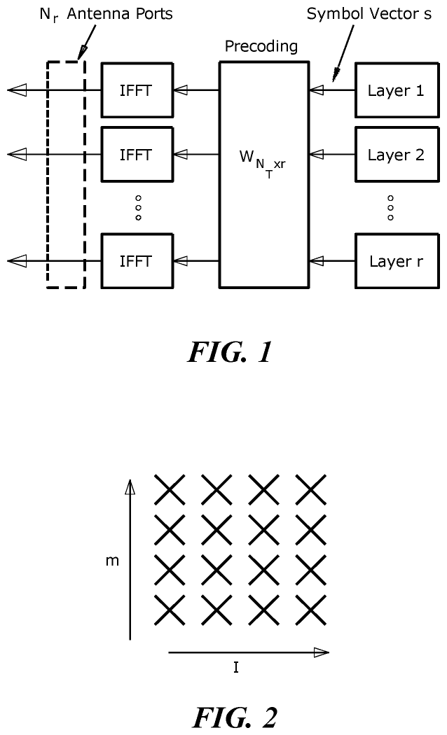

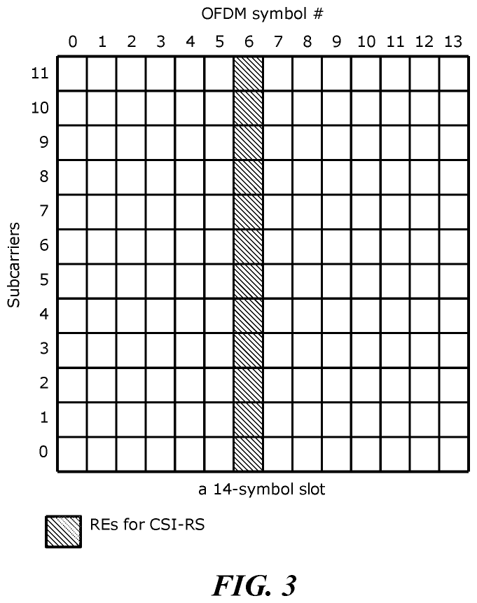

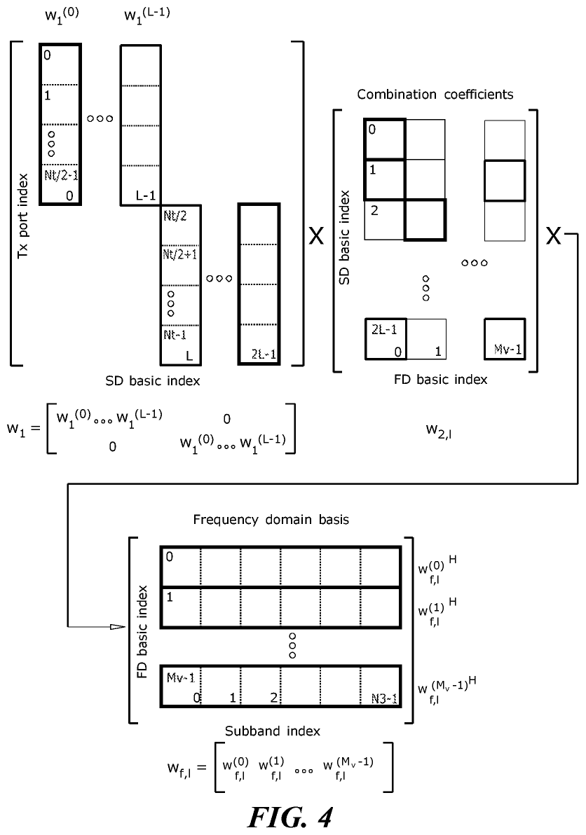

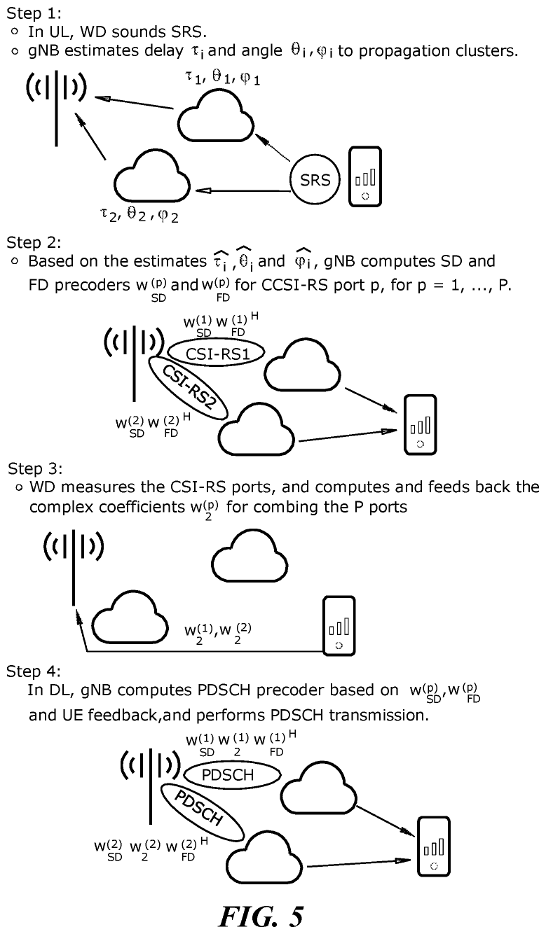

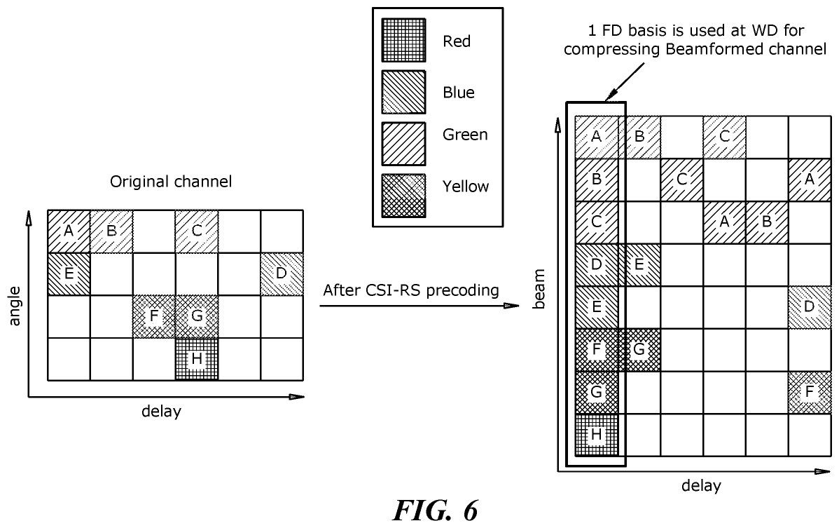

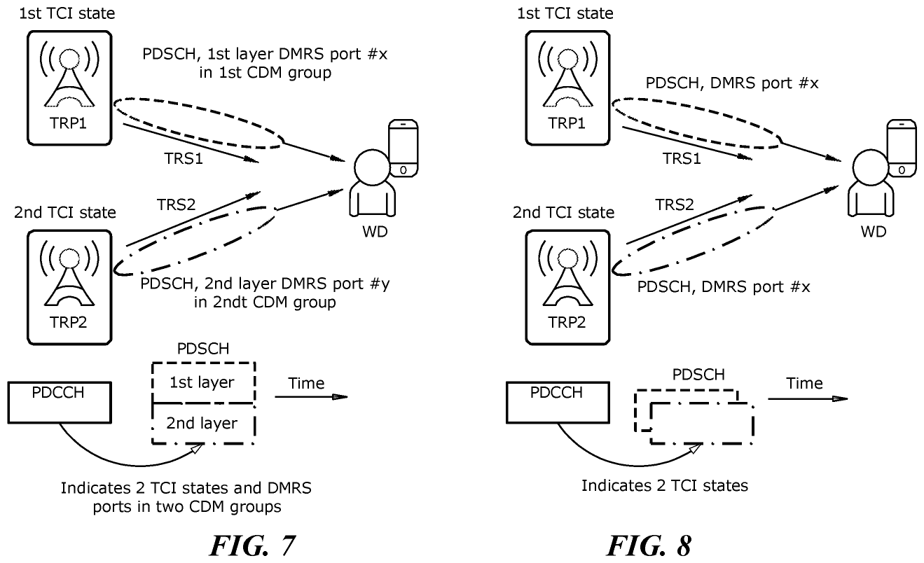

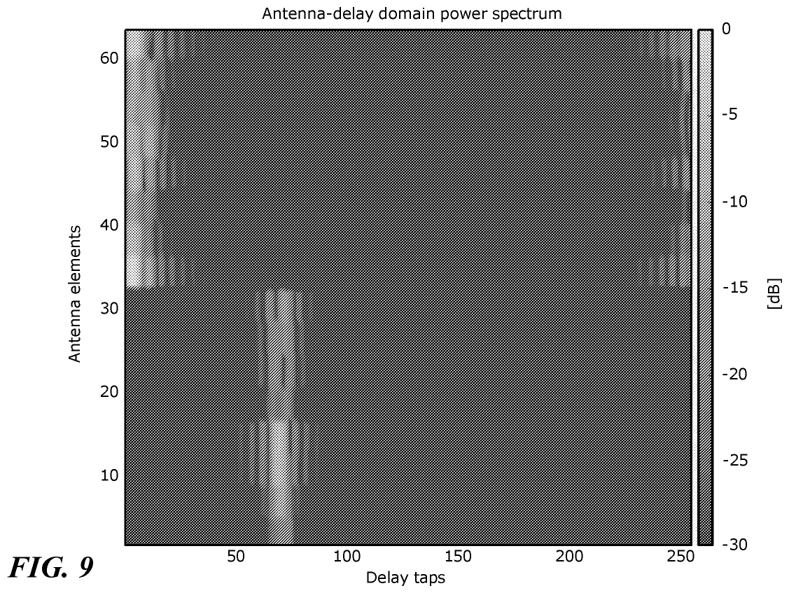

### DETAILED DESCRIPTION

Before describing in detail example embodiments, it is noted that the embodiments reside primarily in combinations of apparatus components and processing steps related to Type II precoder matrix indicator (PMI) for coherent joint transmission (CJT). Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide Type II precoder matrix indicator (PMI) for coherent joint transmission (CJT).

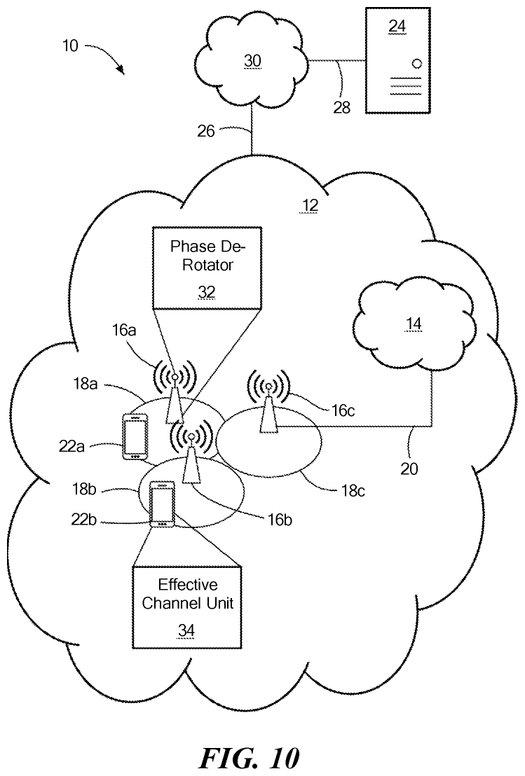

Referring again to the drawing figures, in which like elements are referred to by like reference numerals, there is shown in FIG. 10 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a. 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 10 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a phase de-rotator 32 which may be configured to determine a downlink precoder by applying a phase de-rotation for each subband of a precoder indicated by a received Type II PMI based at least in part on a received inter-TRP delay spread. The phase de-rotator 32 may also be configured to apply a phase rotation to each of a plurality of frequency domain, FD, basis vectors indicated by the Type II PMI, the phase rotation being based at least part on the timing difference associated with a corresponding TRP. The phase de-rotator 32 may be configured to apply a time pre-compensation to a physical downlink channel at each of the plurality of TRPs according to at least one of the time difference and the phase slope associated with the TRP. A wireless device 22 is configured to include an effective channel unit 34 which may be configured to determine an effective downlink channel based at least in part on removing the timing difference from the downlink channel for each TRP. More particularly, the effective channel unit 34 may be configured to determine an effective downlink channel based at least in part on removing an effect of the timing difference from a channel measurement performed on a channel state information reference signal, CSI-RS, resource for each TRP of the at least one TRP. The effective channel unit 34 may also be configured to determine based at least in part on measurements of the plurality of downlink CSI-RS resources, for each TRP of the plurality of TRPs, at least one of: a downlink time difference relative to a reference timing; and a downlink phase slope representing a downlink time difference relative to a reference timing.

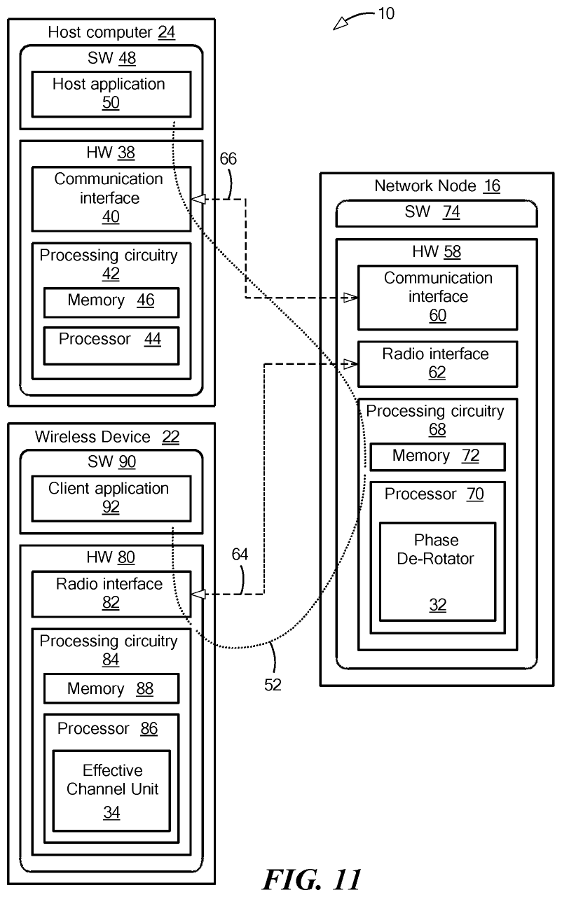

Example implementations, in accordance with an embodiment, of the WD 22, network node 16 and host computer 24 discussed in the preceding paragraphs will now be described with reference to FIG. 11. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a phase de-rotator 32 which is configured to determine a downlink precoder by applying a phase de-rotation for each subband of a precoder indicated by the received Type II PMI based at least in part on the received inter-TRP delay spread. The phase de-rotator 32 may also be configured to apply a phase rotation to each of a plurality of frequency domain, FD, basis vectors indicated by the Type II PMI, the phase rotation being based at least part on the timing difference associated with a corresponding TRP. The phase de-rotator 32 may be configured to apply a time pre-compensation to a physical downlink channel at each of the plurality of TRPs according to at least one of the time difference and the phase slope associated with the TRP.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include an effective channel unit 34 which is configured to determine an effective downlink channel based at least in part on removing the timing difference from the downlink channel for each TRP. The effective channel unit 34 may be configured to determine an effective downlink channel based at least in part on removing an effect of the timing difference from a channel measurement performed on a channel state information reference signal, CSI-RS, resource for each TRP of the at least one TRP. The effective channel unit 34 may also be configured to determine based at least in part on measurements of the plurality of downlink CSI-RS resources, for each TRP of the plurality of TRPs, at least one of: a downlink time difference relative to a reference timing; and a downlink phase slope representing a downlink time difference relative to a reference timing. In some embodiments, the inner workings of the network node 16, WD 22, and host computer 24 may be as shown in FIG. 11 and independently, the surrounding network topology may be that of FIG. 10.

In FIG. 11, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 10 and 11 show various “units” such as phase de-rotator 32 and effective channel unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

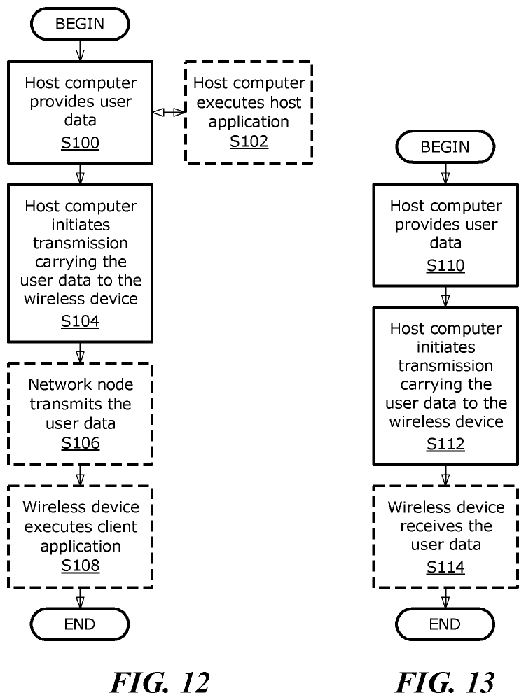

FIG. 12 is a flowchart illustrating an example method implemented in a communication system, such as, for example, the communication system of FIGS. 10 and 11, in accordance with one embodiment. The communication system may include a host computer 24, a network node 16 and a WD 22, which may be those described with reference to FIG. 11. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 13 is a flowchart illustrating an example method implemented in a communication system, such as, for example, the communication system of FIG. 10, in accordance with one embodiment. The communication system may include a host computer 24, a network node 16 and a WD 22, which may be those described with reference to FIGS. 10 and 11. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

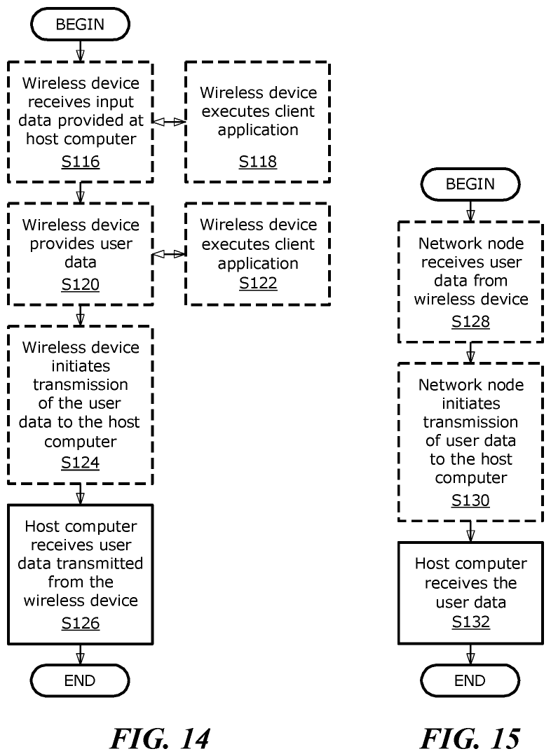

FIG. 14 is a flowchart illustrating an example method implemented in a communication system, such as, for example, the communication system of FIG. 10, in accordance with one embodiment. The communication system may include a host computer 24, a network node 16 and a WD 22, which may be those described with reference to FIGS. 10 and 11. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 15 is a flowchart illustrating an example method implemented in a communication system, such as, for example, the communication system of FIG. 10, in accordance with one embodiment. The communication system may include a host computer 24, a network node 16 and a WD 22, which may be those described with reference to FIGS. 10 and 11. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

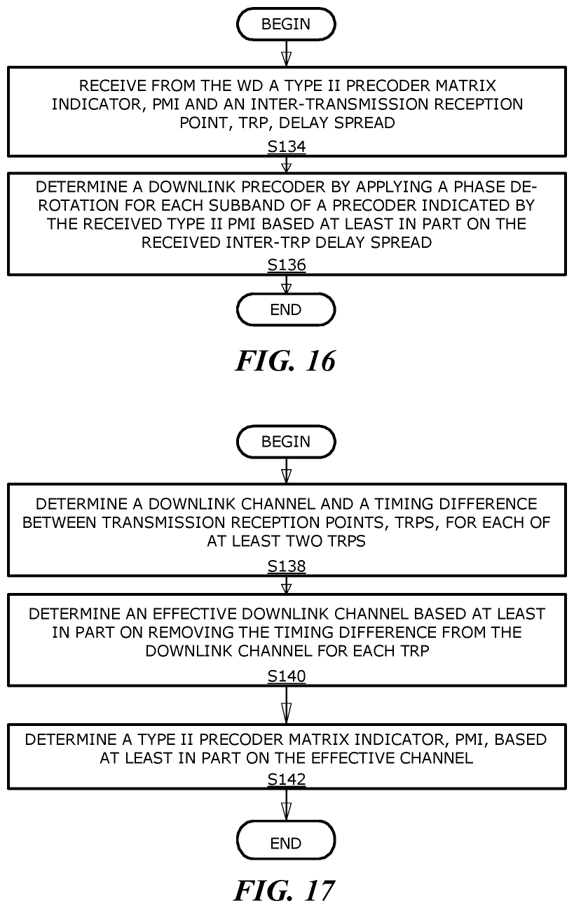

FIG. 16 is a flowchart of an example process in a network node 16 for Type II precoder matrix indicator (PMI) for coherent joint transmission (CJT). One or more blocks described herein may be performed by one or more elements of network node 16 such as by one or more of processing circuitry 68 (including the phase de-rotator 32), processor 70, radio interface 62 and/or communication interface 60. Network node 16 such as via processing circuitry 68 and/or processor 70 and/or radio interface 62 and/or communication interface 60 is configured to receive from the WD a Type II precoder matrix indicator, PMI and an inter-transmission reception point, TRP, delay spread (Block S134). The process also includes determining a downlink precoder by applying a phase de-rotation for each subband of a precoder indicated by the received Type II PMI based at least in part on the received inter-TRP delay spread (Block S136). In some embodiments, applying the phase de-rotation includes applying a phase rotation to a physical downlink shared channel, PDSCH, transmitted from a first TRP and applying no phase rotation to a same PDSCH transmitted from a second TRP.

FIG. 17 is a flowchart of an example process in a wireless device 22 according to some embodiments of the present disclosure. One or more blocks described herein may be performed by one or more elements of wireless device 22 such as by one or more of processing circuitry 84 (including the effective channel unit 34), processor 86, radio interface 82 and/or communication interface 60. Wireless device 22 such as via processing circuitry 84 and/or processor 86 and/or radio interface 82 is configured to determine a downlink channel and a timing difference between transmission reception points. TRPs, for each of at least two TRPs (Block S138). The process also includes determining an effective downlink channel based at least in part on removing the timing difference from the downlink channel for each TRP (Block S140). The process further includes determining a Type II precoder matrix indicator, PMI, based at least in part on the effective channel (Block S142).

In some embodiments, a timing difference is determined with respect to a reference TRP. In some embodiments, the reference TRP is associated with a channel state information reference signal, CSI-RS resource. In some embodiments, determining the effective channel includes removing a delay factor from at least one channel of at least one TRP, the delay factor being based at least in part on the timing difference between the at least one TRP and another TRP. In some embodiments, determining a Type II precoder matrix indicator, PMI, is based at least in part on a cascaded channel matrix of two TRPs. In some embodiments, the process also includes determining a quantized phase slope based at least in part on the timing difference between TRPs, In some embodiments, the process also includes reporting n−1 timing differences to the network node for n TRPs used for coherent joint transmission.

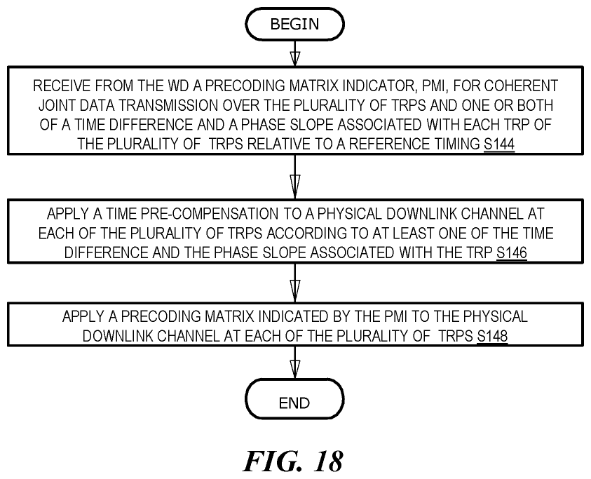

FIG. 18 is a flowchart of an example process in a network node 16 for Type II precoder matrix indicator (PMI) for coherent joint transmission (CJT). One or more blocks described herein may be performed by one or more elements of network node 16 such as by one or more of processing circuitry 68 (including the phase de-rotator 32), processor 70, radio interface 62 and/or communication interface 60. Network node 16 such as via processing circuitry 68 and/or processor 70 and/or radio interface 62 and/or communication interface 60 is configured to receive from the WD a precoding matrix indicator, PMI, for coherent joint data transmission over the plurality of TRPs and one or both of a time difference and a phase slope associated with each TRP of the plurality of TRPs relative to a reference timing (Block S144). The method also includes applying a time pre-compensation to a physical downlink channel at each of the plurality of TRPs according to at least one of the time difference and the phase slope associated with the TRP (Block S146). The method further includes applying a precoding matrix indicated by the PMI to the physical downlink channel at each of the plurality of TRPs (Block S148).

According to this aspect, in some embodiments, the time difference is received as one of a phase change per resource block, RB, a phase change per subcarrier frequency, or a phase change per subband, wherein a subband consists of a number of RBs. In some embodiments, the time pre-compensation to the physical downlink channel is performed by applying a time advance or a time delay on the physical downlink channel according to the time difference. In some embodiments, the time pre-compensation to the physical downlink channel is performed by applying a phase shift per subcarrier, per RB, or per subband in a frequency domain to the physical downlink channel according to the phase slope. In some embodiments, the PMI comprises at least an indicator of a plurality of one or both of spatial beams and spatial domain, SD, basis vectors associated to each of the plurality of TRPs, and an indicator of at least one of frequency domain. FD, basis vectors and co-phasing coefficients each associated to one of the plurality of spatial beams or SD basis vectors associated to each of the plurality of TRPs and to one of the one or more FD basis vectors. In some embodiments, the phase slope is represented by a frequency domain, FD, basis vector, where an index of the FD basis vector is received as part of the PMI. In some embodiments, the reference timing is a downlink timing associated to a reference TRP, wherein the reference TRP is one of the plurality of TRPs. In some embodiments, the reference TRP is at least one of pre-defined and indicated by the WD 22. In some embodiments, each TRP of the plurality of TRPs is associated with a different channel state information reference signal, CSI-RS, resource.

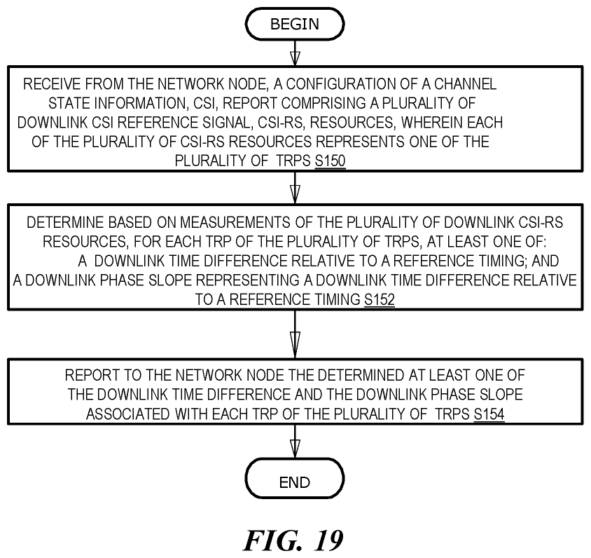

FIG. 19 is a flowchart of an example process in a wireless device 22 according to some embodiments of the present disclosure. One or more blocks described herein may be performed by one or more elements of wireless device 22 such as by one or more of processing circuitry 84 (including the effective channel unit 34), processor 86, radio interface 82 and/or communication interface 60. Wireless device 22 such as via processing circuitry 84 and/or processor 86 and/or radio interface 82 is configured to receive from the network node 16, a configuration of a channel state information, CSI, report comprising a plurality of downlink CSI reference signal, CSI-RS, resources, wherein each of the plurality of CSI-RS resources represents one of the plurality of TRPs (Block S150). The method includes determining based at least in part on measurements of the plurality of downlink CSI-RS resources, for each TRP of the plurality of TRPs, at least one of: a downlink time difference relative to a reference timing; and a downlink phase slope representing a downlink time difference relative to a reference timing (Block S152). The method also includes reporting, to the network node 16, the determined at least one of the downlink time difference and the downlink phase slope associated with each TRP of the plurality of TRPs (Block S154).

According to this aspect, in some embodiments, the processing circuitry is further configured to: determine, for each of the plurality of TRPs, an effective downlink channel based at least in part on removing an effect of the at least one of the downlink time difference and the downlink phase slope associated to the TRP from a channel measurement performed on a CSI-RS resource associated to the TRP; determine a precoder matrix indicator, PMI, based at least in part on the effective downlink channels for coherent joint data transmission from the plurality of TRPs to the WD 22; and the radio interface is further configured to transmit, to the network node 16, the determined PMI. In some embodiments, the PMI indicates a precoding matrix for each of a plurality of subbands, wherein a subband includes a number of resource blocks, RBs. In some embodiments, determining a PMI is based at least in part on the effective downlink channels of the plurality of TRPs. In some embodiments, the PMI includes at least an indicator of a plurality of one or both of spatial beams and spatial domain, SD, discrete Fourier Transform, DFT, basis vectors associated to each of the plurality of TRPs, an indicator of at least one frequency domain, FD, DFT basis vector, and co-phasing coefficients associated to each one of the plurality of one or both of the spatial beams and SD basis vectors associated to each of the plurality of TRPs and at least one of the at least one FD basis vector. In some embodiments, the phase slope associated to each TRP of the plurality of TRPs is reported as a phase change per subband. In some embodiments, the phase slope associated to each TRP of the plurality of TRPs is quantized and represented by a frequency domain, FD, discrete Fourier transform, DFT, basis vector, wherein the FD DFT basis vector is reported for each of the plurality of TRPs as part of the PMI. In some embodiments, the reference timing is a downlink timing acquired by the WD 22 previously based on a downlink reference signal, RS, wherein the downlink RS can be a tracking reference signal, TRS. In some embodiments, the reference timing is a downlink timing associated to a reference TRP, wherein the downlink time difference associated with each TRP is a time delay difference at the WD 22 between a CSI-RS resource associated to the TRP and a CSI-RS resource associated to the reference TRP, and wherein the time difference associated to the reference TRP is zero and is not reported. In some embodiments, the reference TRP is one of the plurality of TRPs. In some embodiments, the reference TRP is explicitly indicated by the network node 16. In some embodiments, the reference TRP is implicitly indicated by the network node 16. In some embodiments, the reference TRP is determined by the WD 22. In some embodiments, the reference TRP is prespecified in specifications. In some embodiments, the method includes transmitting to the network node 16 an indication of which TRP of the plurality of TRPs is the reference TRP. In some embodiments, a time difference associated to each of the plurality of TRPs is reported as at least one of a phase change per resource block, RB, and per number of RBs. In some embodiments, determining the effective channel includes removing a delay factor from a channel measurement associated with a TRP of the plurality of TRPs, the delay factor being based at least in part on the time difference between the TRP and the reference TRP.

Having described the general process flow of arrangements of the disclosure and having provided examples of hardware and software arrangements for implementing the processes and functions of the disclosure, the sections below provide details and examples of arrangements for Type II precoder matrix indicator (PMI) for coherent joint transmission (CJT).

The term TRP may be represented by a TCI state, an NZP CSI-RS resource, or a subset of ports within an NZP CSI-RS resource.

For coherent joint transmission, a user receives coherently transmitted channels/signals from multiple TRPs. The total delay spread of the channel between the WD 22 and the multiple TRPs is generally larger than when the WD 22 receives a channel/signal from a single TRP, particularly when the average propagation delays from the multiple TRPs to the WD 22 are different.

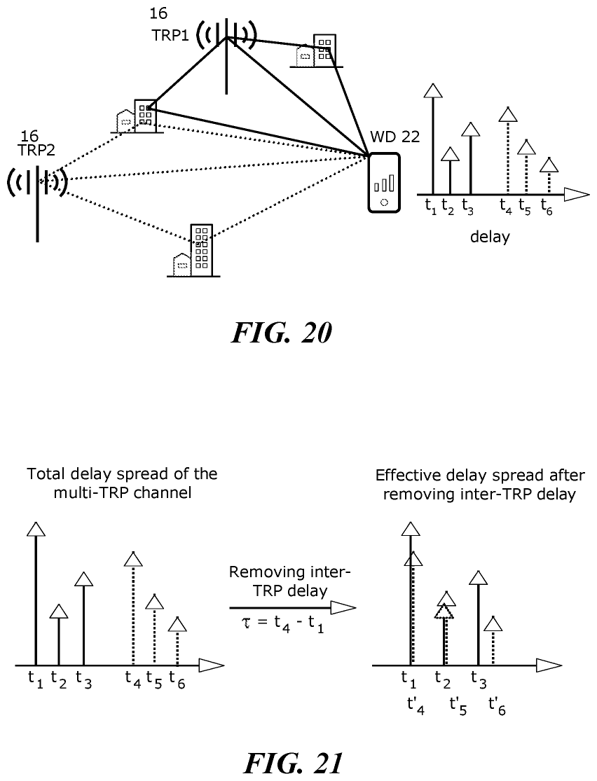

The above is further illustrated with an example shown in FIG. 20, where the WD 22 receives a channel/signal from two geometrically separated TRPs. Between the WD 22 and each individual TRP, there exist three propagation paths in the channel, which introduces delay spread. As seen in this figure, t₁, t₂ and t₃ are the three delay taps associated with TRP 1 while t₄, t₅ and t₆ are the delay taps associated with TRP 2. The total delay spread for the combined channel between the WD 22 and TRP 1 and 2 is determined by all 6 of the delay taps. However, if only the channel between the WD 22 with each individual TRP is considered, there are only three channel taps, which means a much lower delay spread.

The NR Type II codebooks, including the enhanced Type II codebook (CB) and the enhanced Type II port-selection (PS) CB in 3GPP Rel-16, and the further enhanced Type II PS CB in 3GPP Rel-17 (hereafter called the 3GPP Rel-16 Type II CB, the 3GPP Rel-16 PS CB and the 3GPP Rel-17 PS CB, respectively, for the sake of simplicity), may be applied to compress and report the channel state information (CSI) in the delay domain (or equivalently, the frequency domain).

To be more specific, each selected frequency domain (FD) basis vectors in W_{f} of the enhanced Type II precoding matrix may be associated with a dominant delay tap. For the above example, if existing enhanced Type II codebooks are used for CSI reporting, a total number of 6 FD basis vectors are needed to capture all the taps in the combined channel. Since the number of linear combining coefficients in W₂, which is the most pay-load heavy part of a Type II CSI report, scales with the number of FD basis vectors, having more FD basis vectors also means larger overhead for reporting W₂.

Referring to FIG. 21, the total delay spread has two contributions: the intra-TRP delay spread which is caused by the multi-path propagation between the WD 22 and each individual TRP, and the inter-TRP delay spread which is caused by the propagation delay difference (also referred to herein as timing difference) due to the two TRPs being geometrically separated (hence, having different distances to the WD 22). The impact of the inter-TRP delay spread essentially adds a common offset for the intra-TRP delay spread.

Based on the above observation, it is reasonable to treat the intra-TRP (i.e., within the same TRP) delay spread and inter-TRP (i.e., between different TRPs) delay spread separately, in order to reduce the required overhead for capturing the large total delay spread for the combined channel. In particular, the inter-TRP delay spread may be estimated and reported separately. Then, the inter-TRP delay spread may be removed from the part of the combined channel that is associated with the corresponding TRP and an effective channel may be obtained. Finally, the intra-TRP delay spread associated with multiple TRPs may be compressed jointly based at least in part on the effective channel with fewer FD basis vectors.

The above method for separately processing inter-TRP and intra-TRP delay spread is further explained in FIG. 21. The total delay spread of the original combined multi-TRP channel is shown on the left-hand side of FIG. 21, while the effective delay spread of the effective channel after removing the inter-TRP delay (i.e., the propagation delay differences between different TRPs to the WD 22) is shown on the right-hand side of FIG. 21. In this example, the inter-TRP delay is given by τ=t₄−t₁. After removing the inter-TRP delay τ for TRP 2, the effective channel only contains 4 delay taps, compared to 6 delay taps in the original channel. Hence, 4 FD basis vectors are sufficient to capture all the delay taps in the effective channel. Consequently, the number of coefficients in W₂ may also be reduced accordingly.

In addition, larger delay spread means a higher frequency selective channel and thus, smaller coherent bandwidth. Smaller coherent bandwidth requires smaller subband size for CSI feedback such that the channel (both amplitude and phase) does not change significantly within a subband. This yields more subbands for a given bandwidth.

### General Procedure of the Proposed Type II Reporting Enhancement

A general procedure of the proposed Type II CSI reporting enhancement for multi-TRP coherent joint transmission may be summarized in the following steps:
Step 1: WD 22, such as via processing circuitry 84 estimates DL channel and timing difference between served TRPs;
Step 2: WD 22 removes the timing difference for the corresponding TRPs and obtains an effective DL channel;
Step 3: Based on the effective DL channel, the WD 22 calculates a Type II PMI;
Step 4: The WD 22 reports a Type II CSI that contains both the PMI and the timing difference between the served TRPs; and/or
Step 5: Network node 16, e.g., the gNB, applies a precoding matrix associated to the type II PMI together with a phase rotation based at least in part on the reported timing difference between the served TRPs.

In Step 1, the WD 22 estimates the DL channel and also the timing difference between the served TRPs. The timing difference may be the inter-TRP delay between two given TRPs.

When estimating the timing difference, a reference TRP may be used, so that the reported timing difference is calculated with respect to a common reference TRP. The reference TRP may be specified explicitly in NR 3GPP specifications, or it may be deduced from the CSI report configuration. For example, when it is explicitly specified in NR 3GPP specifications, it may be associated with an explicitly configured CSI-RS resource; when it is implicitly deduced, it may be associated with a pre-determined CSI-RS resource, such as the first CSI-RS resource in the CSI report configuration. In some cases, instead of the term ‘reference TRP’, a ‘reference CSI-RS resource for deriving the timing difference between TRPs’ may be used in 3GPP specifications.

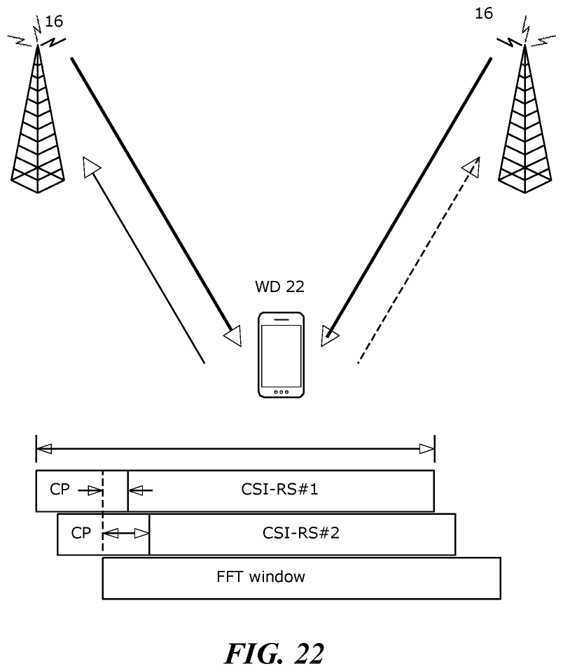

An example is shown in FIG. 22, where two CSI-RS resources are transmitted from two TRPs in an OFDM system. τ₁ and τ₂ are the time delays associated with the first delay tap corresponding to TRP1 and TRP2, respectively. The delay may result in a phase slope over frequency as e^{-j2πfτ}^{ᵢ}, i=1,2. The observed channels at the WD are H₁e^{-j2πfτ}^{₁} for TRP1 and H₂e^{-j2πfτ}^{₂} for TRP2. τ₂−τ₁ is the timing difference between TRP2 and TRP1.

In the above embodiments, the timing difference between different TRPs may be estimated based at least in part on different CSI-RS resources (i.e., each TRP corresponding to a different CSI-RS resource). Note that in some alternative embodiments, the timing difference between TRPs may be estimated based at least in part on a subset of ports within a single CSI-RS resource. For example, in some embodiments, different subsets of ports may correspond to different TRPs, and the WD 22 estimates the channels corresponding to each TRP on one of the subset of ports within the single CSI-RS resource.

In Step 2, the WD 22 obtains an effective DL channel after removing the estimated timing difference from the channel associated with the corresponding TRP. In the above example, the timing difference may be estimated with respect to TRP1, i.e., τ₂−τ₁. The effective channels, H₁ and H₂, are obtained by removing the delay factors e^{-j2πfτ}^{₁} and e^{-j2πfτ}^{₂} from the measured channel H₁e^{-j2πfτ}^{₁} and H₂e^{-j2πfτ}^{₂}, respectively.

Alternatively, the effective channel for TRP2 is obtained by removing the timing difference factor, e^{-j2πf(τ}^{₂}^{-τ}^{₁}⁾, from the measured channel H₂e^{-j2πfτ}^{₂} as H₂e^{-j2πfτ}^{₁}. In this case, TRP1 is used as the reference TRP and the timing difference is computed with respect to TRP1. Hence, the effective channel for TRP1 is directly given by the measured channel H₂e^{-j2πfτ}^{₁}.

In Step 3, the WD 22 calculates a Type II PMI based at least in part on the cascaded effective DL channel, e.g., H=[H₁ H₂] in the example shown in Step 2. The Type II PMI may follow the same general structure as the 3GPP Rel-16 Type II codebooks or the 3GPP Rel-17 Type II codebook. However, the spatial domain (SD) basis vectors become a block diagonal matrix, with each block corresponding to the SD basis vectors for one of the TRPs. In the example discussed in Step 2, the precoding matrix at a PMI subband n (n=1, . . . , N₃) associated with the type II PMI may be expressed as

$$W ( n ) = [ \begin{matrix}{W}_{1} ( n ) \\ {W}_{2} ( n )\end{matrix} ] ,$$

where W₁(n) is associated with TRP1 and W₂(n) with TRP2, N₃ being the number of PMI subbands.

In addition to the above Type II PMI components from existing 3GPP Rel-16/17 Type II codebooks, the WD 22 may also report the timing-difference between each of the configured TRPs for type II based CJT CSI feedback and a reference TRP in the configured TRPs. For example, τ₂−τ₁ in the example discussed in Step 2.

For a given frequency, the timing difference between two TRPs may result in a phase difference, i.e., e^{-j2πf(τ}^{₂}^{-τ}^{₁}⁾, between signals received from the two TRPs. The phase difference changes linearly over frequency and a phase slope is sufficient to characterize this timing difference.

In one embodiment, the phase slope is quantized between 0 and 2π and reported to the network node 16 as part of the Type II CSI report. Since CSI-RS has one channel sample per RB for each CSI-RS port, phase change or slope may only be measured in a granularity of per RB. Therefore, in one embodiment, phase change over one RB between the measured channels associated with two CSI-RS resources may be reported, i.e., φ_{τ}=−2πΔf(τ₂−τ₁), where Δf is the bandwidth per RB in Hertz. φ_{τ} may be quantized between 0 to 2π.

In another embodiment, the quantized phase slope may be represented by a FD basis vector, which is taken from a DFT matrix, possibly with oversampling in frequency (e.g., sampled per RB instead of per PMI subband in existing type II CSI). The index of the corresponding FD basis vector is reported to the network node 16. The length of the FD basis vector, i.e., the size of the DFT matrix, may be different from that for the FD basis vectors used for compressing the effective channel. A larger DFT matrix size may more accurately remove the inter-TRP delays.

Denote the number of TRPs that are used for coherent joint transmission as n. Then in some embodiments at least n−1 timing differences need to be reported. In some embodiments, which timing differences are reported from the WD 22 to the network node 16 depends on which TRPs are selected as part of the Type II CSI feedback. In some embodiments, the WD 22 may be configured for n different CSI-RS resources (i.e., n TRPs), and the WD 22 selects SD basis vectors or CSI-RS ports from only a subset n′<n of CSI-RS resources as part of the Type II CSI feedback (i.e., n′ TRPs are selected by the WD 22 for coherent joint transmission). In this case, only n′−1 timing differences need to be reported, and the reference CSI-RS resource (or reference TRP) for computing the timing differences may be identified using one of the embodiments above.

The timing difference may result in frequency selectivity. In some other embodiments, a per FD subband phase change between each of multiple TRPs and a reference TRP, due to timing difference, is reported to the network node 16.

In Step 4, the WD 22 includes the timing difference(s) as part of the Type II CSI report and reports the timing difference(s) to the network node 16.

The timing difference(s) may be reported to the network node 16 in CSI report Part 1, since it is a large-scale fading channel property.

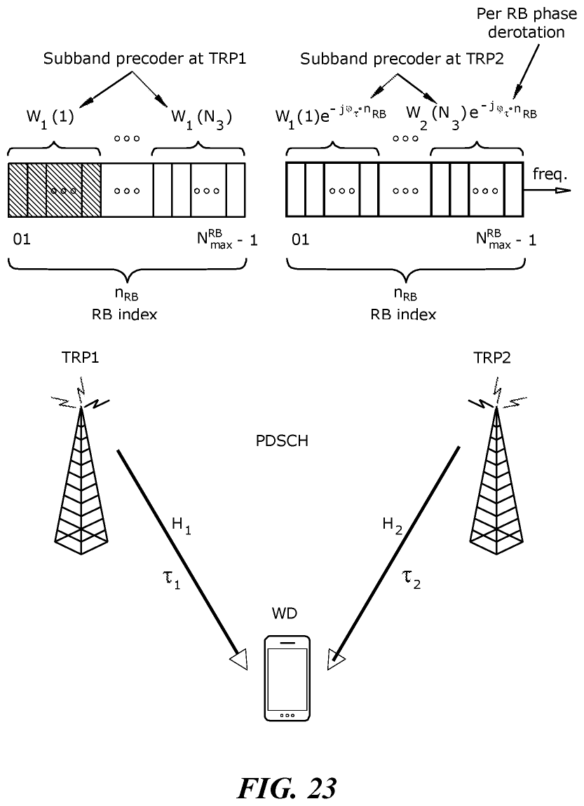

In Step 5, the network node 16 applies a precoding matrix per subband together with a phase de-rotation per RB based at least in part on the reported timing difference φ_{τ}. This is illustrated in FIG. 23, where per subband precoders {W₁(n), n=1, . . . , N₃} reported by the WD 22 are applied to a PDSCH transmitted from TRP1 and per subband precoders {W₂(n), n=1, . . . , N₃} reported by the WD 22 are combined with a phase de-rotation factor e^{-jφ}^{_{τ}}^{·n}^{_{RB}} per RB are applied to the same PDSCH transmitted from TRP2 for CJT, where N₃ is the number of PMI subbands and n_{RB} is a RB index. The phase de-rotation is effectively a delay pre-compensation for the timing difference between the two TRPs. Alternatively, the phase de-rotation may be applied per sub-carrier instead of per RB with a per subcarrier phase de-rotation amount of φ_{τ}/N_{sc}, where N_{sc} is the number subcarriers per RB.

Although two TRPs are used for discussion in the above examples, the ideas may be easily extended to more than two TRPs.

Some embodiments may include one or more of the following:

Embodiment A1. A network node configured to communicate with a wireless device, WD, the network node configured to, and/or comprising a radio interface and/or comprising processing circuitry configured to:
receive from the WD a Type II precoder matrix indicator, PMI and an inter-transmission reception point, TRP, delay spread; and
determine a downlink precoder by applying a phase de-rotation for each subband of a precoder indicated by the received Type II PMI based at least in part on the received inter-TRP delay spread.

Embodiment A2. The network node of Embodiment A1, wherein applying the phase de-rotation includes applying a phase rotation to a physical downlink shared channel, PDSCH, transmitted from a first TRP and applying no phase rotation to a same PDSCH transmitted from a second TRP.

Embodiment B1. A method implemented in a network node configured to communicate with a wireless device, WD, the method comprising:
receiving from the WD a Type II precoder matrix indicator, PMI and an inter-transmission reception point, TRP, delay spread; and
determining a downlink precoder by applying a phase de-rotation for each subband of a precoder indicated by the received Type II PMI based at least in part on the received inter-TRP delay spread.

Embodiment B2. The method of Embodiment B1, wherein applying the phase de-rotation includes applying a phase rotation to a physical downlink shared channel, PDSCH, transmitted from a first TRP and applying no phase rotation to a same PDSCH transmitted from a second TRP.

Embodiment C1. A wireless device (WD) configured to communicate with a network node, the WD configured to, and/or comprising a radio interface and/or processing circuitry configured to:
determine a downlink channel and a timing difference between transmission reception points, TRPs, for each of at least two TRPs;
determine an effective downlink channel based at least in part on removing the timing difference from the downlink channel for each TRP; and
determine a Type II precoder matrix indicator, PMI, based at least in part on the effective channel.

Embodiment C2. The WD of Embodiment C1, wherein a timing difference is determined with respect to a reference TRP.

Embodiment C3. The WD of Embodiment C2, wherein the reference TRP is associated with a channel state information reference signal, CSI-RS resource.

Embodiment C4. The WD of any of Embodiments C1-C3, wherein determining the effective channel includes removing a delay factor from at least one channel of at least one TRP, the delay factor being based at least in part on the timing difference between the at least one TRP and another TRP.

Embodiment C5. The WD of any of Embodiments C1-C4, wherein determining a Type II precoder matrix indicator, PMI, is based at least in part on a cascaded channel matrix of two TRPs.

Embodiment C6. The WD of any of Embodiments C1-C5, wherein the WD, radio interface and/or processing circuitry are further configured to determine a quantized phase slope based at least in part on the timing difference between TRPs.

Embodiment C7. The WD of any of Embodiments C1-C6, wherein the WD, radio interface and/or processing circuitry are further configured to report n−1 timing differences to the network node for n TRPs used for coherent joint transmission.

Embodiment D1. A method implemented in a wireless device (WD), the method comprising
determining a downlink channel and a timing difference between transmission reception points, TRPs, for each of at least two TRPs;
determining an effective downlink channel based at least in part on removing the timing difference from the downlink channel for each TRP; and
determining a Type II precoder matrix indicator, PMI, based at least in part on the effective channel.

Embodiment D2. The method of Embodiment D1, wherein a timing difference is determined with respect to a reference TRP.

Embodiment D3. The method of Embodiment D2, wherein the reference TRP is associated with a channel state information reference signal, CSI-RS resource.

Embodiment D4. The method of any of Embodiments D1-D3, wherein determining the effective channel includes removing a delay factor from at least one channel of at least one TRP, the delay factor being based at least in part on the timing difference between the at least one TRP and another TRP.

Embodiment D5. The method of any of Embodiments D1-D4, wherein determining a Type II precoder matrix indicator, PMI, is based at least in part on a cascaded channel matrix of two TRPs.

Embodiment D6. The method of any of Embodiments D1-D5, further comprising determining a quantized phase slope based at least in part on the timing difference between TRPs.

Embodiment D7. The method of any of Embodiments D1-D6, further comprising reporting n−1 timing differences to the network node for n TRPs used for coherent joint transmission.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python. Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| DFT | Discrete Fourier Transform |
| eType II | enhanced Type II, 3GPP Rel-16 Type II |
| feType II | further enhanced Type II, 3GPP Rel-17 Type II |
| FD | frequency domain |
| LCC | linear combination coefficients |
| SCI | strongest coefficient indicator |
| SD | spatial domain |
| TD | time domain |
| TRP | Transmission and reception point |
| W₁ | A matrix containing all spatial domain basis vectors for a |
| | Type II PMI |
| W_{f} | A matrix containing all frequency domain basis vectors for a |
| | Type II PMI |
| W₂ | A matrix containing complex co-phasing factors for W₁ and |
| | W_{f} |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with a wireless device, WD via a plurality of transmission and reception points, TRPs, the network node comprising:
a radio interface configured to receive from the WD a precoding matrix indicator, PMI, for coherent joint data transmission over the plurality of TRPs and one or both of a time difference and a phase slope associated with each TRP of the plurality of TRPs relative to a reference timing; and
processing circuitry in communication with the radio interface and configured to:
apply a time pre-compensation to a physical downlink channel at each of the plurality of TRPs according to at least one of the time difference and the phase slope associated with the TRP; and
apply a precoding matrix indicated by the PMI to the physical downlink channel at each of the plurality of TRPs.

2.-9. (canceled)

10. A method in a network node configured to communicate with a wireless device, WD, via a plurality of transmission and reception points, TRPs, the method comprising:
receiving from the WD a precoding matrix indicator, PMI, for coherent joint data transmission over the plurality of TRPs and one or both of a time difference and a phase slope associated with each TRP of the plurality of TRPs relative to a reference timing;
applying a time pre-compensation to a physical downlink channel at each of the plurality of TRPs according to at least one of the time difference and the phase slope associated with the TRP; and
applying a precoding matrix indicated by the PMI to the physical downlink channel at each of the plurality of TRPs.

11.-18. (canceled)

19. A wireless device, WD, configured to communicate with a network node, the WD comprising:
a radio interface configured to receive from the network node, a configuration of a channel state information, CSI, report comprising a plurality of downlink CSI reference signal, CSI-RS, resources, wherein each of the plurality of CSI-RS resources represents one of the plurality of TRPs; and
processing circuitry in communication with the radio interface and configured to:
determine based at least in part on measurements of the plurality of downlink CSI-RS resources, for each TRP of the plurality of TRPs, at least one of:
a downlink time difference relative to a reference timing; and
a downlink phase slope representing a downlink time difference relative to a reference timing; and
report to the network node the determined at least one of the downlink time difference and the downlink phase slope associated with each TRP of the plurality of TRPs.

20. The WD of claim 19, wherein:
the processing circuitry is further configured to:
determine, for each of the plurality of TRPs, an effective downlink channel based at least in part on removing an effect of the at least one of the downlink time difference and the downlink phase slope associated to the TRP from a channel measurement performed on a CSI-RS resource associated to the TRP; and
determine a precoder matrix indicator, PMI, based at least in part on the effective downlink channels for coherent joint data transmission from the plurality of TRPs to the WD; and
the radio interface is further configured to transmit, to the network node, the determined PMI.

21. The WD of claim 20, wherein the PMI indicates a precoding matrix for each of a plurality of subbands, wherein a subband includes a number of resource blocks, RBs.

22. The WD of claim 20, wherein determining a PMI is based at least in part on the effective downlink channels of the plurality of TRPs.

23. The WD of claim 20, wherein the PMI includes at least an indicator of a plurality of one or both of spatial beams and spatial domain, SD, discrete Fourier Transform, DFT, basis vectors associated to each of the plurality of TRPs, an indicator of at least one frequency domain, FD, DFT basis vector, and co-phasing coefficients associated to each one of the plurality of one or both of the spatial beams and SD basis vectors associated to each of the plurality of TRPs and at least one of the at least one FD basis vector.

24. The WD of claim 19, wherein the phase slope associated to each TRP of the plurality of TRPs is reported as a phase change per subband.

25. The WD of claim 19, wherein the phase slope associated to each TRP of the plurality of TRPs is quantized and represented by a frequency domain, FD, discrete Fourier transform, DFT, basis vector, wherein the FD DFT basis vector is reported for each of the plurality of TRPs as part of the PMI.

26. The WD of claim 19, wherein the reference timing is a downlink timing acquired by the WD previously based at least in part on a downlink reference signal, RS, wherein the downlink RS can be a tracking reference signal, TRS.

27. The WD of claim 19, wherein the reference timing is a downlink timing associated to a reference TRP, wherein the downlink time difference associated with each TRP is a time delay difference at the WD between a CSI-RS resource associated to the TRP and a CSI-RS resource associated to the reference TRP, and wherein the time difference associated to the reference TRP is zero and is not reported.

28. The WD of claim 19, wherein the reference TRP is one of the plurality of TRPs.

29. The WD of claim 19, wherein the reference TRP is explicitly indicated by the network node.

30. The WD of claim 19, wherein the reference TRP is implicitly indicated by the network node.

31. The WD of claim 19, wherein the reference TRP is determined by the WD.

32. The WD of claim 19, wherein the reference TRP is prespecified in specifications.

33. The WD of claim 19, wherein the radio interface is further configured to transmit to the network node an indication of which TRP of the plurality of TRPs is the reference TRP.

34. The WD of claim 19, wherein a time difference associated to each of the plurality of TRPs is reported as at least one of a phase change per resource block, RB, and per number of RBs.

35. The WD of claim 19, wherein determining the effective channel includes removing a delay factor from a channel measurement associated with a TRP of the plurality of TRPs, the delay factor being based at least in part on the time difference between the TRP and the reference TRP.

36. A method in a wireless device, WD, configured to communicate with a network node comprising a plurality of transmit and reception points, TRPs, the method comprising:
receiving from the network node, a configuration of a channel state information, CSI, report comprising a plurality of downlink CSI reference signal, CSI-RS, resources, wherein each of the plurality of CSI-RS resources represents one of the plurality of TRPs;
determining based at least in part on measurements of the plurality of downlink CSI-RS resources, for each TRP of the plurality of TRPs, at least one of:
a downlink time difference relative to a reference timing; and
a downlink phase slope representing a downlink time difference relative to a reference timing; and
reporting to the network node the determined at least one of the downlink time difference and the downlink phase slope associated with each TRP of the plurality of TRPs.

37.-52. (canceled)
